(19) United States
(12) Patent Application Publication
(10) Pub. No.: US 2024/0376016 A1
(43) Pub. Date: Nov. 14, 2024

(54) NANOFIBERS AND METHODS OF FORMING NANOFIBERS THEREOF

(71) Applicant: National University of Singapore, Singapore (SG)

(72) Inventors: Valeria Spolon Marangoni, Singapore (SG); Antonio Helio de Castro Neto, Singapore (SG); Mariana Caldeira Ferraz da Costa, Singapore (SG); Ricardo Keitel Donato, Singapore (SG); Hui Li Tan, Singapore (SG)

(21) Appl. No.: 18/683,107

(22) PCT Filed: Aug. 8, 2022
(86) PCT No.: PCT/SG2022/050566

§ 371 Date: Feb. 12, 2024

(30) Foreign Application Priority Data
Aug. 13, 2021 (SG) 10202108866X

(51) Int. Cl. C04B 35/622; D01F 9/08

(52) U.S. Cl. CPC C04B 35/62272; D01F 9/08; C04B 2235/94; C04B 2235/95; D10B 2101/02

(57) ABSTRACT

The present disclosure concerns nanofibers and methods of forming these nanofibers thereof. The method of forming nanofiber comprises providing 2D materials with charge bearing moieties on its planar surfaces and at its ends, reacting the charge bearing moieties on the planar surfaces with proton donors, proton acceptors, at least partially hydrophobic counterions or a second 2D materials with oppositely charge bearing moieties on its planar surfaces and at its ends in order to curl the 2D material, simultaneously reacting the charge bearing moieties at the ends with proton donors, proton acceptors, at least partially hydrophobic counterions or the second 2D materials with oppositely charge bearing moieties on its planar surfaces and at its ends, and crosslinking the neutralised charge bearing moieties at the ends in order for the 2D materials to interact with each other to form the nanofiber.

### Technical Field

The present invention relates, in general terms, to nanofibers and methods of forming these nanofibers thereof.

### BACKGROUND

Since the advent of graphene in 2004, several methods have been developed for producing scalable and high quality graphene. These methods can be roughly divided into two categories: 1) Top-down; 2) Bottom-up. Top-down methods start with graphite and reduce the graphite size in number of layers down to one or few layers. This is the case of liquid phase exfoliation (LPE) methods. Bottom-up approaches start from molecular size materials and grow them to large size, as in the case of chemical vapor deposition (CVD). These approaches have both pros and cons. In LPE one can obtain micrometer size, single crystal, flakes with several number of layers while in CVD one obtains monolayer poly-crystalline macroscopic films. In most cases, however, graphene needs further modifications to make their size, surface and morphology suitable to meet the technological demands.

Beyond 2D graphene, carbon based nanomaterials can adopt a large variety of structures, such as the 1D morphologies: carbon nanotubes, scrolls, and fibres. The creation of systems with responsive conformational changes (2D↔1D) is also of great relevance for a wide range of applications, including drug-delivery, hydrogen storage, sensors, membranes for filtration, and structures for mimicking biological systems, such as muscle filaments and microtubules, and aerospace and automotive industries. Graphene fibers, specifically, are of great interest for applications in smart electronic fibrous devices, textiles and as flexible and wearable electronics and sensors. Due to their high aspect ratio, lightweight and resistance, they are also very promising for personal protective equipment, thermal management and reinforcement for automotive and aeronautic industry. The possibility to adjust the interlayer distance and high conductive make them attractive for energy applications, such as batteries and super capacitors. Furthermore, their high aspect ratio and the possibility to entwine along each other and form cross-linked structures can allow the creation of enhanced membranes for air and water purification and aerogel with controlled and reduced porous size. In medicine, for example, fibrillar materials can reproduce the filamentous nature of the extracellular matrix, serving as outstanding tools for tissue engineering and regenerative medicine.

Graphene fibers, with high aspect ratio and thickness at nanoscale, are usually produced by templates methods, such as the carbonization of polypyrrole nanofiber, pyrolysis of bacterial cellulose or using Tellurium (Te) nanowires with a very high aspect ratio, in this last case Te@Carbon are obtained by an hydrothermal carbonization process from glucose and in presence of the Te nanowires, followed by removal of the Te cores by chemical approach. Therefore, controllable fabrication of high aspect ratio and high-quality ID graphene fibers from graphene sheets in suspensions under template-free and mild conditions remains a challenge. Macroscopic graphene fibers, with diameter greater than 60 μm, are usually produced by wet spinning process similarly to that used to produce polymer fibers.

It would be desirable to overcome or ameliorate at least one of the above-described problems.

### SUMMARY

The present invention is predicated on the understanding that nanofiber assembly can be governed by short- and long-range interactions, such as covalent and hydrogen bonding, hydrophobic interactions, ionic interactions, and n-n stacking. In this regard, it was found that 2D-electrolytes, that are 2D materials with ionic groups attached to their surface that can deprotonate in a liquid medium, can undergo morphological transition, in a similar way to polyelectrolytes, followed by self assembly and cross linking in the presence of bifunctional molecules, which lead to the formation of long nanofibers. The assembly can also be performed between two different types of 2D electrolytes, called as heterostructure nanofiber. Another approach involves 2D-confined electrolytes, which are 2D materials with organic/inorganic salt on its basal plane and the presence of using another organic/inorganic salt results in ion-exchanging and destabilization of the system, causing phase separation/coagulation into fibers. This catalysts-free and self-template approach allows for the incorporation of 2D electrolytes into higher aspect ratio composite nanofibers using mild conditions, such as aqueous media and room temperature.

The present invention provides a method of forming a nanofiber, comprising:
a) providing 2D materials with charge bearing moieties on its planar surfaces and at its ends; and
b) reacting the charge bearing moieties on the planar surfaces with proton donors, proton acceptors, at least partially hydrophobic counterions or a second 2D materials with oppositely charge bearing moieties on its planar surfaces and at its ends in order to curl the 2D material, and
c) simultaneously reacting the charge bearing moieties at the ends with proton donors, proton acceptors, at least partially hydrophobic counterions or the second 2D materials with oppositely charge bearing moieties on its planar surfaces and at its ends, and crosslinking the reacted charge bearing moieties at the ends in order for the 2D materials of step b) to interact with each other to form the nanofiber.

It was found that the charge bearing moieties allows for better dispersion of the nanomaterial in an aqueous medium. For example, graphene can be dispersed in water only after the functionalization. The charge bearing moieties also maintains the 2D material in its planar configuration until its reaction to form nanofibers. The charge bearing moieties can also induce some conformational changes depending on some specific conditions such as pH, and sonication time. In this sense, the charge bearing moieties are configured to lose their charge by neutralisation. Further, by providing charge bearing moieties on the surfaces of the nanomaterial, the rate of crosslinking can be controlled by varying reaction conditions such as pH, and bifunctional or polyfunctional crosslinkers. In this way, the growth of the nanofibers can be controlled.

In some embodiments, the charge bearing moieties are selected from protonated moieties, deprotonated moieties, cationic moieties or anionic moieties.

In some embodiments, the method is performed in an aqueous medium.

In some embodiments, the method is performed at about 10° C. to about 50° C.

In some embodiments, the method does not rely on a template in order to form the nanofiber.

In some embodiments, the 2D material is selected from graphene, graphene oxide, few-layer transition-metal dichalcogenides, hexagonal boron nitride or a combination thereof.

In some embodiments, the few-layer transition-metal dichalcogenides is selected from MoS₂, MoSe₂, MoTe₂, WS₂, or WSe₂.

In some embodiments, the 2D materials is at least about 50% functionalised with the charge bearing moieties.

In some embodiments, the charge bearing moieties are reacted by varying the pH.

In some embodiments, the reacting step b) and/or c) is performed at a pH of about 3 to about 6.

In some embodiments, the reacting step b) and/or c) is performed at a pH of about 4.

In some embodiments, the at least partially hydrophobic counterion is selected from imidazolium, pyridinium, piperidinium, ammonium, phosphonium, imide, sulfonate, sulphate, borate, phosphate, carboxylate or their derivative thereof.

In some embodiments, the 2D material with oppositely charge bearing moieties is selected from graphene, graphene oxide few-layer transition-metal dichalcogenides, hexagonal boron nitride or a combination thereof.

In some embodiments, the 2D materials with oppositely charge bearing moieties is at least about 50% functionalised with the charge bearing moieties.

In some embodiments, step (b) further comprises crosslinking the reacted charge bearing moieties on the planar surfaces.

In some embodiments, the crosslinking is performed in the presence of a crosslinker.

In some embodiments, the crosslinker comprises at least two cross linking moieties.

In some embodiments, a weight ratio of the crosslinker relative to the 2D material is about 50:1 to about 700:1.

In some embodiments, at least step b) is performed under ultrasonication and/or stirring.

In some embodiments, the ultrasonication is for at least 10 min at about 3° C. to about 10° C.

In some embodiments, the method further comprises a step of functionalising 2D materials with charge bearing moieties in order to form the 2D materials with charge bearing moieties of step a).

In some embodiments, the step of functionalising 2D materials with charge bearing moieties is performed at a pH of about 5 to about 6.9.

In some embodiments, the step of functionalising 2D materials with charge bearing moieties is performed under ultrasonication.

In some embodiments, the ultrasonication is for at least 10 min at about 3° C. to about 10° C.

In some embodiments, the ultrasonication is for at least 30 min at about 3° C. to about 10° C.

In some embodiments, the step of functionalising 2D materials with charge bearing moieties is performed for at least 2 h.

In some embodiments, the step of functionalising 2D materials with charge bearing moieties is performed for at least 72 h.

In some embodiments, the step of functionalising 2D materials with charge bearing moieties is performed at about 20° C. to about 70° C.

In some embodiments, when the 2D material is graphene, the step of functionalising 2D materials with charge bearing moieties is performed at about 45° C.

In some embodiments, when the 2D material is MoS₂, the step of functionalising 2D materials with charge bearing moieties is performed at about 20° C. to about 40° C.

In some embodiments, when the 2D material is graphene, the step of functionalising 2D materials with charge bearing moieties is performed under an inert atmosphere.

In some embodiments, when the pH is maintained and/or counterions is in excess, the method is self perpetuating until all 2D materials are reacted.

In some embodiments, the method of forming a nanofiber, comprises:
a) providing 2D materials with protonated or deprotonated moieties on its planar surfaces and at its ends; and
b) reacting the protonated or deprotonated moieties on the planar surfaces with proton donors or proton acceptors in order to curl the 2D materials, and
c) simultaneously reacting the protonated or deprotonated moieties at the ends with proton donors or proton acceptors and covalently crosslinking the reacted moieties at the ends in order for the 2D materials of step b) to interact with each other to form the nanofiber.

In some embodiments, the protonated or deprotonated moieties are carboxylate moieties.

In some embodiments, the carboxylate moiety is a carboxyl compound selected from 5-azidopentanoic acid, 6-azido-hexanoic acid, azido-dPEG₄-acid, azido palmitic acid, azidoacetic acid, mercaptopropionic acid, mercaptoacetic acid, 5-mercaptopentanoic acid, or a combination thereof.

In some embodiments, the charge bearing moieties are neutralised by varying the pH.

In some embodiments, step b) and/or c) is performed at a pH of about 3 to about 6.

In some embodiments, step b) further comprises covalently crosslinking the reacted protonated or deprotonated moieties on the planar surfaces.

In some embodiments, the protonated or deprotonated moieties are covalently crosslinked with poly or bifunctional amino compounds.

In some embodiments, amino compounds comprises at least two amino moieties.

In some embodiments, the amino compound is triethylenetetramine, triethylenediamine, ethylenedimine, p-phenylenediamine, or a combination thereof.

In some embodiments, the crosslinking is performed in the presence of 1-ethyl-3-(3-dimethylaminopropyl)carbodiimide (EDC) and N-hydroxysuccinimide (NHS).

In some embodiments, step b) and step c) are performed for at least 1 h at about 3° C. to about 30° C.

In some embodiments, step b) and step c) are performed for at least 12 h at about 3° C. to about 10° C.

In some embodiments, step b) and step c) are performed for at least 72 h at about 3° C. to about 10° C.

In some embodiments, the method of forming a nanofiber in an aqueous medium, comprises:
a) providing 2D materials with cationic or anionic moieties on its planar surfaces and at its ends; and
b) reacting the cationic or anionic moieties on the planar surfaces with at least partially hydrophobic counterions in order to curl the 2D material, and
c) simultaneously reacting the cationic or anionic moieties at the ends with at least partially hydrophobic counterions and ionically crosslinking the reacted charge bearing moieties at the ends in order for the 2D materials of step b) to interact with each other to form the nanofiber.

In some embodiments, the cationic or anionic moieties are electrostatically bonded to the 2D materials.

In some embodiments, a ratio of 2D materials to the cationic or anionic moieties is about 1:30 to about 1:80.

In some embodiments, a ratio of 2D materials to the cationic or anionic moieties is about 1:50.

In some embodiments, the cationic or anionic moieties are organic cationic or anionic moieties.

In some embodiments, the anionic moiety is bis(trifluoromethane)sulfonimide.

In some embodiments, the anionic moiety is provided as a salt selected from lithium bis(trifluoromethane)sulfonimide.

In some embodiments, the charge bearing moieties are reacted with counterions having an opposite charge relative to the cationic or anionic moieties on the 2D material.

In some embodiments, the counterions are organic counterions.

In some embodiments, the counterion is selected from imidazolium, pyridinium, piperidinium, ammonium, phosphonium, imide, sulfonate, sulphate, borate, phosphate, carboxylate or their derivative thereof.

In some embodiments, the counterion is 1-butyl-3-methylimidazolium.

In some embodiments, the counterion is provided by a salt selected from 1-butyl-3-methylimidazolium methanesulfonate.

In some embodiments, a ratio of 2D materials with cationic or anionic moieties to the counterions is about 1:30 to about 1:80.

In some embodiments, a ratio of 2D materials with cationic or anionic moieties to the counterions is about 1:50.

In some embodiments, step b) further comprises ionically crosslinking the reacted cationic or anionic moieties on the planar surfaces.

In some embodiments, at least step b) is performed under ultrasonication.

In some embodiments, the ultrasonication is performed for at least 10 min at about 3° C. to about 10° C.

In some embodiments, the method further comprises a step of functionalising 2D materials with cationic or anionic moieties in order to form the 2D materials with cationic or anionic moieties of step a).

In some embodiments, the step of functionalising 2D materials with cationic or anionic moieties is performed under ultrasonication in the presence of cationic or anionic moieties.

In some embodiments, the ultrasonication is performed for at least 10 min at about 3° C. to about 10° C.

In some embodiments, when the 2D material is graphene, the method further comprises a step before step a) of exfoliating graphite in the presence of the cationic or anionic moieties.

In some embodiments, the graphite and the cationic or anionic moieties are dispersed in an aqueous medium and organic medium mixture in a ratio of about 95:5. In some embodiments, the aqueous medium and organic medium are immiscible.

In some embodiments, the exfoliation step is performed under high power probe ultrasonication.

In some embodiments, the method of forming a nanofiber in an aqueous medium, comprises:
a) providing 2D materials with cationic or anionic moieties on its planar surfaces and at its ends; and
b) reacting the cationic or anionic moieties on the planar surfaces with another 2D materials with oppositely charge bearing moieties on its planar surfaces and at its ends in order to curl the 2D material, and
c) simultaneously reacting the cationic or anionic moieties at the ends with the another 2D materials with oppositely charge bearing moieties on its planar surfaces and at its ends and ionically crosslinking the reacted charge bearing moieties at the ends in order for the 2D materials of step b) to interact with each other to form the nanofiber.

In some embodiments, a weight ratio of the 2D materials relative to the another 2D materials is about 1:1.

In some embodiments, the method comprises reacting the 2D materials with the another 2D materials in a flow reactor.

The present invention also provides a nanofiber, wherein the nanofiber is characterised by a solid or semi-hollow cross sectional profile; wherein the nanofiber is characterised by a layered cross sectional profile of 2D materials curled up and bonded to each other at their planar surfaces and ends; and wherein the 2D materials are selected from graphene, graphene oxide, few-layer transition-metal dichalcogenides, hexagonal boron nitride or a combination thereof.

In some embodiments, the nanofiber is characterised by a diameter of about 5 nm to about 400 nm.

In some embodiments, the nanofiber is characterised by a diameter of about 10 nm to about 100 nm.

In some embodiments, the diameter is inhomogeneous.

In some embodiments, the nanofiber is characterised by a length of about 1 μm to about 100 μm.

In some embodiments, the nanofiber is characterised by a length of about 5 μm to about 50 μm.

In some embodiments, the nanofiber is characterised by an aspect ratio of about 30 to about 3000.

In some embodiments, the nanofiber is semicrystalline.

In some embodiments, when the nanofiber is a graphene nanofiber, the nanofiber is characterised by an interlayer spacing of about 0.40 nm to 0.5 nm.

In some embodiments, when the nanofiber is a graphene nanofiber, the nanofiber is characterised by an interlayer spacing of about 0.40 nm to 0.45 nm.

In some embodiments, when the nanofiber is a graphene nanofiber, the nanofiber is characterised by amide bonds.

In some embodiments, when the nanofiber is a graphene nanofiber crosslinked by amide moieties, the nanofiber is characterised by an X-ray photoelectron spectroscopy peak at about 288 eV to about 290 eV.

In some embodiments, when the nanofiber is a graphene nanofiber crosslinked by amide moieties, the nanofiber is characterised by FTIR peaks at about 1653 cm⁻¹ and about 1572 cm⁻¹.

### BRIEF DESCRIPTION OF THE DRAWINGS

Embodiments of the present invention will now be described, by way of non-limiting example, with reference to the drawings in which:

FIG. 1. Schematic representation of the synthesis of 2D-electrolyte nanofibers. Functionalization of graphene with (a) lower (G-COOH) and (b) higher degree (G-COOHhc) of functionalization. Further functionalization of G-COOH using (c) EDC, NHS and TETA molecules and the controls, using exclusively (d) EDC/NHS or (e) TETA. STEM images of all steps, where the light grey structure in the background is the lacey carbon support film on the TEM grid.

FIG. 2. XPS characterization of the nanofibers. High resolution C1s and N1s XPS comparing graphene, G-COOH and nanofibers.

FIG. 3. Morphological and structural analyses of 2D-electrolytes nanofibers. (a,b,c) SEM images and (d,e) HR-STEM for nanofibers structures, where the graphene is located inside the fibers. (f,g,h) SEM images and (i,j) HR-STEM for nanofibers, where graphene is assembled on the surface of the amorphous phase.

FIG. 4. Raman characterization of 2D-electrolytes nanofibers. (a) and (b) Intensity maps of the “D”, “G” and “2D” bands, respectively. Raman excitation laser wavelength is 532 nm.

FIG. 5. Theory analysis of fiber formation. Chemical bonds responsible for cross-linking scrolls along (a) their edges or (b) at the surface. C, H, N, and O atoms are represented in gray, white, blue and red, respectively. The enthalpy of reaction is given above the arrow. (c) two random scrolls having too large size mismatch cannot entwine, (d) scrolls of comparable sizes can entwine and form a fiber.

FIG. 6. SEM images of the fibers and particle size distribution histograms.

FIG. 7. FTIR spectra comparing graphene before and after the functionalisations (G-COOH and nanofibers).

FIG. 8. SEM images at different stages of the reaction (in all cases the pH is around 6.5).

FIG. 9. AFM images with the respective height profile for the nanofibers (a,b).

FIG. 10. XRD difratograms of graphene and hBN-based fibers compared to their pristine precursor materials.

FIG. 11. Raman spectroscopy of graphene and hBN-based fibers.

FIG. 12. Morphological and compositional characterization of graphene and hBN fibrillated systems using; polarized light optical microscopy (POM) with cross-polarization demonstrating the optical anisotropy of the materials; scanning (SEM) and transmission electron microscopy (TEM) demonstrating the fibrillar morphology of the materials; high-resolution TEM (HRTEM) and selected area electron diffraction (SAED) highlighting the organization and high crystallinity of the system; and Energy-dispersive spectroscopy (EDS) confirming the preservation of the original chemical composition of the 2D materials after fibrillation.

FIG. 13. Characterization of the graphene nanofibers. (a) Optical, (b) STEM, (c) SEM representative images, and (d) the respective particle size distribution.

FIG. 14. XPS characterization of the synthesis variations. High resolution C1s and N1s XPS comparing graphene, G-COOH-hc, G-COOH-EDC/NHS and G-COOH-TETA.

FIG. 15. Characterization of the control sample containing only EDC/NHS/TETA (no graphene). (a) SEM images and (b) C1s and N1s High-resolution XPS spectra of the samples prepared in the absence of functionalized graphene (no G-COOH).

FIG. 16. SEM images of heterostructure fibers formed after mixing (a) and sonicated for 5 mins (b); AFM image with the height profiles of the heterostructure fibers measured at different locations; Raman spectra of the heterostructure fibers acquired using a 532 nm laser (c), indicating the presence of both characteristic GO and MoS₂ bands.

### DETAILED DESCRIPTION

The present invention provides methods to produce self-assembled ultralong nanofibers: (i) via a synthetic method to transform functionalized 2D materials (such as 2D-electrolytes) into internally (covalently) cross-linked nanofibers; or (ii) via a two-step self-assembly method to transform exfoliated pristine 2D materials doped with organic salts, confining these salts onto the 2D materials' basal plane (2D-confined electrolytes), into internally (ionically) crosslinked nanofibers. These distinct and template-free approaches are based on the self-assembly of the 2D materials' flakes in aqueous suspensions, which are very attractive due to their possibility of scale-up and typically lower cost.

The first method via 2D-electrolytes, which can consist in the initial covalent functionalization of the 2D materials with an anionic group (e.g. —COO⁻) and further conversion with a cationic group (e.g. —NH₃⁺) to form cationic 2D-electrolytes. Well-defined fibrous structures are formed by 2D-electrolyte scrolling and structural guidance by an organic fibrous network that is simultaneously formed by the crosslinking reactions of the molecules used for functionalization. By changing the charge content of the dispersion (for instance, by changing the pH) the surface charge density of a 2D material can be electrically screened and, due to its elasticity and binding energy, undergoes a conformational change to a 1D-like structures such as scrolls. Further crosslinking at the terminal ends of the 2D material extends the scrolls into a nanofiber. This method has the advantage of a controlled functionalization of the materials and a living polymerization profile of the fibers, since they continue growing longitudinally while in the liquid medium with precursors available (free 2D-electrolytes).

The second method via 2D-confined electrolytes, which can consist in the initial assembly and confinement of an organic/inorganic salt onto the 2D materials basal plane, forming 2D-confined electrolytes, and further addition of another organic/inorganic salt for ion-exchanging and destabilization of the system, causing phase separation/coagulation into fibers. When opposite charges are conjugated to the organic/inorganic salt on the 2D-confined electrolytes, they decrease the binding capacity of the organic/inorganic salt with other species, and forms a strong Coulomb interaction that “crosslinks” the charge bearing groups between the two (or more) conjugated ionic groups. This method has the advantage of not affecting the pristine properties of the 2D materials used, since it does not involve direct covalent functionalization, and the salts that are not directly confined in the 2D lattices, and stay in solution, can be recycled for further use. Moreover, the salts can be applied directly into the exfoliation process, where the organic salts act simultaneously as surfactants/stabilizing agents and as 2D materials doping/modification agent.

As used herein, “2D material” refers to crystalline solids consisting of a single layer or few layers of atoms. Such single-layer or few layers materials derived from single elements generally carry the -ene suffix in their names, e.g. graphene. Single-layer or few layers materials that are compounds of two or more elements have -ane or -ide suffixes. 2D materials can generally be categorized as either 2D allotropes of various elements or as compounds (consisting of two or more covalently bonding elements).

As used herein, “2D-electrolyte” refer to 2D material, such as graphene, graphene oxide (GO), reduced graphene oxide (rGO), and molybdenum disulfide (MoS₂), with different chemical groups that can be either protonation or deprotonation in dispersion and become positively (2D cations) or negatively (2D anions) electrically charged, respectively.

As used herein, “2D-confined electrolyte” refer to 2D material, such as graphene, graphene oxide (GO), reduced graphene oxide (rGO), and molybdenum disulfide (MoS₂), with different organic ions located at the surface of the 2D material and are electrostatically associated to the surface. The organic ions can be derived from an organic salt and can either be an organic cation or an organic anion. These ions confined on the surface of the 2D material can be exchanged with free ions in solution. Accordingly, the present invention provides a method of forming a nanofiber, comprising:
a) providing 2D materials with charge bearing moieties on its planar surfaces and at its ends; and
b) reacting the charge bearing moieties on the planar surfaces with proton donors, proton acceptors, at least partially hydrophobic counterions or 2D materials with oppositely charge bearing moieties on its planar surfaces and at its ends in order to curl the 2D material, and
c) simultaneously reacting the charge bearing moieties at the ends with proton donors, proton acceptors, at least partially hydrophobic counterions or 2D materials with oppositely charge bearing moieties on its planar surfaces and at its ends, and crosslinking the neutralised charge bearing moieties at the ends in order for the 2D materials of step b) to interact with each other to form the nanofiber.

It was found that the charge bearing moieties allow for homogenous dispersion of the nanomaterial in an aqueous medium. For example, graphene can be dispersed in water only after the functionalization. The charge bearing moieties also maintain the 2D material in its planar configuration until its reaction to form nanofibers. The charge bearing moieties can also induce some conformational changes depending on some specific conditions such as pH, and sonication time. Further, by providing charge bearing moieties on the surfaces of the nanomaterial, the rate of crosslinking can be controlled by varying reaction conditions such as pH, and bifunctional or polyfunctional crosslinkers.

As the charge bearing moieties are configured to lose their charge by neutralisation, the 2D material curls in response to this destabilisation. Charge bearing moieties at the ends of the 2D materials are relatively more exposed and thus preferentially interact with other deprotonated or neutralised charge bearing moieties on other 2D materials to extend the length of the nanofiber. The growth of the nanofibers can be controlled by varying reaction conditions such as pH, and bifunctional or polyfunctional crosslinkers.

Current 2D materials such as graphene obtained by liquid phase exfoliation usually present reduced lateral size, which can limit their applications. In the methods herein presented, the 2D materials are covalently or ionically combined, resulting in ultralong fibers. Once formed, the fibers can continue to grow by self-assembly of the small functionalized or salt-doped 2D materials' flakes.

The method is simple, versatile, template-free and the resulting structures present a very high aspect ratio and diameter at nanoscale, which can be applicable to applications including membranes for filtration, textiles, batteries and sensors. In contrast, all previous methods produce materials with lower aspect ratio and diameters of more than 50 μm of diameter. Moreover, all the methods to produce fibers with diameters at nanoscale reported use templates, which can increase the cost and time of the process.

Furthermore, both methods are mostly performed in aqueous media and room temperature, without the need of any special setup.

The methods allow for selecting the crystallinity of the resulting nanofiber, and consequently the fibers stiffness. The method using 2D-electrolytes via covalent functionalization of the 2D materials disrupts partially their lattice crystallinity, while the method using 2D-confined electrolytes does not involve direct covalent functionalization and conserves the crystallinity of the pristine 2D materials used.

The method using 2D-electrolytes consumes the reactants to exhaustion, leaving little to no residue of the reaction process. Moreover, the method using 2D-confined electrolytes involves the adsorption of organic salts at room temperature onto the 2D materials lattices. It is also a green process as it allows the reutilization of the salts that were not adsorbed for a new batch, avoiding the production of process residues.

Since the organic salts are soluble in water, they allow the direct exfoliation of the 2D materials in water medium, acting as surfactant/stabilizing agents. Moreover, the salts get adsorbed onto the 2D materials lattices, producing the 2D-confined electrolytes, that can be directly applied to the fibrillation process.

The resulting nanofibers can be applied in a large variety of applications including membrane for filtration, systems for gas purification, textiles, electronic fibrous devices, flexible and wearable electronics, sensors, and energy applications, such as batteries and supercapacitors.

As used herein, “charge bearing moiety” refers to a part of an organic or inorganic molecule which has a moiety which can bear/acquire a positive or negative charge. The charge bearing moiety can be a functional group which can be protonated or de-protonated to acquire a charge. Examples of protonated and de-protonated moieties include carboxylate (—COO⁻), protonated amine (such as —NH₃⁺), sulphide (such as —S⁻), and phosphonium (R₃P⁺ optionally functionalised with hydroxyl groups). Alternatively, the charge bearing moiety can be an organic or inorganic ion. Examples of such cations and anions include H⁺, hydroxide, halide, azide, ammonium, nitrate, nitride, nitrite, phosphide, oxide, sulfide, sulfate, sulphite, selenide, triiodide, bifluoride, carbonate, chlorate, chromate, dichromate, cyclopentadienyl, dihydrogen phosphate, hydrogen carbonate (bicarbonate), hydrogen sulfate (bisulfate), hydrogen sulphite (bisulfite), hypochlorite, monohydrogen phosphate, perchlorate, permanganate, peroxide, phosphate, superoxide, thiosulfate, silicate, metasilicate, aluminium silicate, acetate, formate, oxalate, and cyanide.

In some embodiments, the charge bearing moieties are attached to the surface of the 2D material via covalent bonds or via electrostatic interactions.

In some embodiments, the charge bearing moieties is selected from protonated moieties, deprotonated moieties, cationic moieties or anionic moieties. In other embodiments, the charge bearing moieties is protonated moieties or deprotonated moieties. In other embodiments, the charge bearing moieties is cationic moieties or anionic moieties.

In some embodiments, the each charge bearing moiety comprises at least one charge. In other embodiments, the each charge bearing moiety comprises at least two charge. For example, the charge bearing moiety can comprise at least two COO⁻ moieties or at least two NH₃⁺ moieties. The charge bearing moiety can have a valency of 1, 2, 3 or 4. For example, the charge bearing moiety can be a divalent or multivalent ion.

In some embodiments, the method is performed in an aqueous medium.

The term “aqueous solution” used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also fall within this definition. In most embodiments, the aqueous solution is water. In some embodiments, the aqueous solution is deionised water. In some embodiments, the aqueous solution is Millipore water.

In some embodiments, the method is performed at about 10° C. to about 50° C. In other embodiments, the temperature is about 10° C. to about 45° C., about 10° C. to about 40° C., about 10° C. to about 35° C., about 10° C. to about 30° C., about 15° C. to about 30° C., or about 20° C. to about 30° C. In other embodiments, the method is performed at ambient temperature.

In some embodiments, the method does not rely on a template. In other embodiments, the method is template-free.

In some embodiments, the 2D material is selected from graphene, graphene oxide few-layer transition-metal dichalcogenides, hexagonal boron nitride or a combination thereof. In other embodiments, the 2D material is selected from graphene, graphene oxide, reduced graphene oxide, and few-layer transition-metal dichalcogenides, hexagonal boron nitride or a combination thereof.

In some embodiments, the few-layer transition-metal dichalcogenides is selected from MoS₂, MoSe₂, MoTe₂, WS₂, or WSe₂.

In some embodiments, the 2D materials is at least about 50% functionalised with the charge bearing moieties. In other embodiments, the 2D materials is at least about 55%, about 60%, about 65%, about 70%, about 75%, about 80%, about 85%, about 90%, or about 90% functionalised with the charge bearing moieties. In other embodiments, the 2D materials is functionalised about 50% to about 90%, about 60% to about 90%, about 70% to about 90%, or about 80% to about 90%. The functionalisation can be estimated using x-ray photoelectron spectroscopy (XPS).

In some embodiments, the charge bearing moieties are neutralised or reacted by controlling the pH. For example, if the charge bearing moieties are protonated moieties, the pH can be more than about 7, about 7.5, about 8, about 8.5 about 9, about 9.5 or about 10. If the charge bearing moieties are deprotonated moieties, the pH can be less than about 7, about 6.5, about 6, about 5.5, about 5, about 4.5 or about 4. In other embodiments, the charge bearing moieties can be conjugated with at least partially hydrophobic counterions. For example, if the charge bearing moieties are cationic moieties, salts with organic anions can be used. If the charge bearing moieties are anionic moieties, salts with organic cations can be used. The anions and cations can be selected from fully organic salts or inorganic salts that has at least one organic counterion. Just as a few examples of such salts include imidazolium, pyridinium, piperidinium, ammonium and phosphonium salts as sources of cations; and imide, sulfonate, sulphate, borate, phosphate and carboxylate salts as sources of anions.

The phase transition in step b is morphological, that is, occurs through dimensional transformation from/to 2D to/from 1D behaviour, in some cases, in a reversible way. It was found that this transition is a competition between elastic, Coulombic, and van der Waals interactions in a complex and coordinated way. By further destabilising the ends of the 2D materials in a controlled manner (step c), instead of uncontrolled aggregation, in addition to the 2D materials undergo curling in order to minimise its surface energy. The presence of charges also at the edges of the 2D materials allows an adjacent 2D material to connect, thus lengthening the nanomaterial to form nanofibers.

In some embodiments, the reacting step b) and/or c) is performed at a pH of about 3 to about 6. In other embodiments, the pH is about 3 to about 5. In some embodiments, the neutralising step b) and/or c) is performed at a pH of about 4.

The at least partially hydrophobic counterion is selected from salts with at least one organic counterion and which has differing water/organic solvent solubility. It was found that hydrophobic ion pairing can be used to modulate the solubility of the charged hydrophilic 2D materials. When the charged hydrophilic 2D materials are ionically paired with oppositely-charged molecules that include hydrophobic moieties, the resulting uncharged complex tends to be water insoluble and may precipitate in aqueous media. This solubility partition can be a trigger for the controlled coagulation of 2D materials into nanofibers. Inorganic ions are generally very water soluble and isotropic (and hence hydrophilic), while organic ions are generally less water soluble and more anisotropic (and hence at least partially hydrophobic), which allows a controlled reduction of the system stability.

In some embodiments, when the charge bearing moieties are reacted with at least partially hydrophobic counterions, the counterion is an organic counterion. In some embodiments, the counterion is selected from imidazolium, pyridinium, piperidinium, ammonium, phosphonium, imide, sulfonate, sulphate, borate, phosphate, carboxylate or their derivative thereof. In other embodiments, when the charge bearing moieties are neutralised by counterions, the counterion is 1-butyl-3-methylimidazolium. In other embodiments, when the charge bearing moieties are neutralised by counterions, the counterion is provided by a salt selected from 1-butyl-3-methylimidazolium methanesulfonate.

In some embodiment, the charge bearing moieties on the 2D material is reacted with 2D materials with oppositely charge bearing moieties on its planar surfaces and at its ends. In some embodiments, the 2D material with oppositely charge bearing moieties is selected from graphene, graphene oxide few-layer transition-metal dichalcogenides, hexagonal boron nitride or a combination thereof. In other embodiments, the 2D material is selected from graphene, graphene oxide, reduced graphene oxide, and few-layer transition-metal dichalcogenides, hexagonal boron nitride or a combination thereof.

The 2D material with oppositely charge bearing moieties can be of the same or different material compared to the 2D material with charge bearing moieties. In this regard, and in some embodiments, both 2D materials can be independently selected from graphene, graphene oxide few-layer transition-metal dichalcogenides, hexagonal boron nitride, or a combination thereof. Accordingly, either homostructured or heterostructured nanofibers can be formed.

The two 2D materials may have oppositely charge bearing moieties. For example, when the 2D materials have protonated Brønsted-Lowry bases as moieties, the other 2D materials can have deprotonated Brønsted-Lowry acids as moieties. When the 2D materials have cationic moieties, the other 2D materials can have anionic moieties.

In some embodiments, the 2D materials with oppositely charge bearing moieties is at least about 50% functionalised with the charge bearing moieties. In other embodiments, the 2D materials is at least about 55%, about 60%, about 65%, about 70%, about 75%, about 80%, about 85%, about 90%, or about 90% functionalised with the charge bearing moieties. In other embodiments, the 2D materials is functionalised about 50% to about 90%, about 60% to about 90%, about 70% to about 90%, or about 80% to about 90%. The functionalisation can be estimated using x-ray photoelectron spectroscopy (XPS).

The 2D material may have charge bearing moieties on both sides of its surface. As one side is neutralised or reacted and curls to form the inner side, the other side is also simultaneously neutralised or reacted. This exposed outer side may interact with another 2D material to form a layered structure. This results in the diameter of the nanofiber not being uniform throughout its length.

In some embodiments, step (b) further comprises crosslinking the charge bearing moieties on the planar surfaces. The charge bearing moieties may be reacted or neutralised in order to facilitate the crosslinking. The rate of formation of nanofibers can be further controlled by crosslinking the moieties.

In some embodiments, the crosslinking is performed in the presence of a crosslinker. The crosslinker can be a poly or bifunctional molecule or an organic salt. In some embodiments, the crosslinker comprises at least two cross linking moieties. In some embodiments, the crosslinker comprises at least three cross linking moieties.

In some embodiments, when the charge bearing moiety is reacted with at least partially hydrophobic counterions, the crosslinker is the at least partially hydrophobic counterions. In some embodiments, when the charge bearing moiety is reacted with 2D materials with oppositely charge bearing moieties on its planar surfaces and at its ends, the 2D materials with oppositely charge bearing moieties on its planar surfaces and at its ends serves as the crosslinker.

In some embodiments, the weight ratio of crosslinker relative to the 2D material is about 50:1 to about 700:1. In other embodiments, the ratio is about 100:1 to about 700:1, about 150:1 to about 700:1, about 200:1 to about 700:1, about 250:1 to about 700:1, about 300:1 to about 700:1, about 350:1 to about 700:1, about 400:1 to about 700:1, about 450:1 to about 700:1, about 500:1 to about 700:1, about 550:1 to about 700:1, or about 600:1 to about 700:1.

In some embodiments, the crosslinking step b) and/or c) is performed under stirring. In other embodiments, the stirring is performed at about 3° C. to about 10° C., or at about 10° C. The low temperature slows down the crosslinking reaction.

Alternatively, in some embodiments, the crosslinking step b) and/or c) is performed under ultrasonication. In some embodiments, at least step b) is performed under ultrasonication. Sonication is the act of applying sound energy to agitate particles in a sample. Ultrasonic frequencies (>20 kHz) are used in ultrasonication. The sonication can be applied using an ultrasonic bath or an ultrasonic probe, colloquially known as a sonicator.

In some embodiments, the ultrasonication is for at least about 10 min at about 3° C. to about 10° C., or at about 10° C. In other embodiments, the duration is for at least about 15 min, or about 20 min. In some embodiments, the ultrasonication is for at least about 30 min at about 3° C. to about 10° C.

In some embodiments, the crosslinking step c) is performed at about 3° C. to about 10° C., or at about 10° C. in the absence of an external force such as stirring or sonication.

In some embodiments, the method further comprises a step of functionalising 2D materials with charge bearing moieties in order to form the 2D materials with charge bearing moieties of step a).

In some embodiments, a weight ratio of the charge bearing moiety relative to the 2D material is about 2:1 to about 5:1. In other embodiments, the weight ratio of the charge bearing moiety relative to the 2D material is about 3:1.

In some embodiments, the step of functionalising 2D materials with charge bearing moieties is performed at a pH of about 5 to about 6.9. In other embodiments, the pH is about 5 to about 6.5, or about 5 to about 6.

In some embodiments, the step of functionalising 2D materials with charge bearing moieties is performed under ultrasonication.

In some embodiments, the ultrasonication is for at least about 10 min at about 3° C. to about 10° C., or at about 10° C. In other embodiments, the duration is for at least about 15 min, or about 20 min. In some embodiments, the ultrasonication is for at least about 30 min at about 3° C. to about 10° C., or at about 10° C.

In some embodiments, the step of functionalising 2D materials with charge bearing moieties is performed for at least about 2 h. In other embodiments, the duration is for at least about 4 h, about 6 h, about 8 h, about 12 h, about 16 h, about 20 h, about 24 h, about 28 h, about 32 h, about 36 h, about 40 h, about 44 h, about 48 h, about 52 h, about 56 h, about 60 h, about 64 h, or about 68 h. In some embodiments, the step of functionalising 2D materials with charge bearing moieties is performed for at least 72 h.

In some embodiments, the step of functionalising 2D materials with charge bearing moieties is performed at about 20° C. to about 70° C. In other embodiments, the temperature is about 20° C. to about 60° C., about 20° C. to about 50° C., about 25° C. to about 50° C., about 30° C. to about 50° C., about 35° C. to about 50° C., or about 40° C. to about 50° C. In some embodiments, the step of functionalising 2D materials with charge bearing moieties is performed at about 45° C. In some embodiments, when the 2D material is graphene, the step of functionalising 2D materials with charge bearing moieties is performed at about 45° C. In some embodiments, when the 2D material is MoS₂, the step of functionalising 2D materials with charge bearing moieties is performed at about 20° C. to about 40° C.

In some embodiments, when the 2D material is graphene, the step of functionalising 2D materials with charge bearing moieties is performed under an inert atmosphere. The inert atmosphere can be nitrogen, or a noble gas such as argon. In other embodiments, the step of functionalising 2D materials with charge bearing moieties is performed under ambient conditions (room temperature and in open air).

In some embodiments, when the pH is maintained and/or counterions is in excess, the method is self perpetuating until all 2D materials are reacted. In this regard, the reaction goes to completion until there is no unreacted 2D material remaining.

In some embodiments, the method of forming a nanofiber, comprises:
a) providing 2D materials with protonated or deprotonated moieties on its planar surfaces and at its ends; and
b) reacting the protonated or deprotonated moieties on the planar surfaces with proton donors or proton acceptors in order to curl the 2D material, and
c) simultaneously reacting the protonated or deprotonated moieties at the ends with proton donors or proton acceptors, and covalently crosslinking the reacted moieties at the ends in order for the 2D materials of step b) to interact with each other to form the nanofiber.

The method of forming a nanofiber can be performed in an aqueous medium.

In some embodiments, the protonated or deprotonated moieties are carboxylate moieties. In some embodiments, the carboxylate moiety is a carboxyl compound selected from 5-azidopentanoic acid, 6-azido-hexanoic acid, azido-dPEG₄-acid, azido palmitic acid, azidoacetic acid, mercaptopropionic acid, mercaptoacetic acid, 5-mercaptopentanoic acid, or a combination thereof.

In some embodiments, the charge bearing moieties are neutralised by varying the pH.

In some embodiments, step b) and/or c) is performed at a pH of about 3 to about 6. In other embodiments, the pH is about 3 to about 5. In some embodiments, step b) and/or c) is performed at a pH of about 4.

In some embodiments, step b) further comprises covalently crosslinking the protonated or deprotonated moieties on the planar surfaces. The protonated or deprotonated moieties on the planar surfaces (for example —COOH or —COO⁻) may be reacted (for example to —OH or OH₂⁺) in order to facilitate the cross linking.

In some embodiments, the reacted moieties on the planar surfaces are covalently crosslinked with a crosslinker. The crosslinking is configured to occur intraplanar on the 2D material surface and on an inner surface of the nanofiber. The crosslinker can be an amino compound. In some embodiments, the amino compound comprises at least two or at least three amino moieties. In this regard, the amino compound can be a poly or bifunctional amino compound.

In some embodiments, the amino compound is triethylenetetramine, triethylenediamine, ethylenedimine, p-phenylenediamine, or a combination thereof.

In some embodiments, the crosslinking is performed in the presence of 1-ethyl-3-(3-dimethylaminopropyl)carbodiimide (EDC) and N-hydroxysuccinimide (NHS). EDC and NHS activates the functional groups such that cross coupling to form amide bonds can be performed at a lower activation energy. In this way, the amino compound can be conjugated to the carboxyl compound on the 2D material via an amide bond, which then by nature of the additional amino moiety on the amino compound, forms amide crosslinks with another carboxyl compound.

In some embodiments, step b) and step c) are performed for at least 1 h at about 3° C. to about 30° C. In other embodiments, the duration is for at least about 4 h, about 6 h, about 8 h, about 12 h, about 16 h, about 20 h, about 24 h, about 28 h, about 32 h, about 36 h, about 40 h, about 44 h, about 48 h, about 52 h, about 56 h, about 60 h, about 64 h, about 68 h, or about 72 h. In other embodiments, the temperature is about 3° C. to about 30° C., about 3° C. to about 25° C., about 3° C. to about 20° C., about 3° C. to about 15° C., about 3° C. to about 10° C., or about 10° C.

In some embodiments, step b) and step c) are performed for at least 12 h at about 3° C. to about 10° C. In some embodiments, step b) and step c) are performed for at least 72 h at about 3° C. to about 10° C.

In some embodiments, the method of forming a nanofiber, comprises:
a) providing 2D materials with protonated or deprotonated moieties on its planar surfaces and at its ends; and
b) reacting the protonated or deprotonated moieties on the planar surfaces with proton donors or proton acceptors in order to form reacted moieties and covalently crosslinking the reacted moieties with a crosslinker; and
c) simultaneously reacting the protonated or deprotonated moieties at the ends with proton donors or proton acceptors, and covalently crosslinking the reacted moieties at the ends in order for the 2D materials of step b) to interact with each other to form the nanofiber.

In some embodiments, the method of forming a nanofiber, comprises:
a) providing 2D materials with deprotonated moieties on its planar surfaces and at its ends; and
b) protonating the deprotonated moieties on the planar surfaces with proton donors in order to form reacted moieties and covalently crosslinking the reacted moieties with a crosslinker; and
c) simultaneously protonating the deprotonated moieties at the ends with proton donors, and covalently crosslinking the reacted moieties at the ends in order for the 2D materials of step b) to interact with each other to form the nanofiber.

In some embodiments, the method of forming a nanofiber, comprises:
a) providing 2D materials with deprotonated moieties on its planar surfaces and at its ends; and
b) protonating the deprotonated moieties on the planar surfaces with proton donors in order to form reacted moieties and covalently crosslinking the reacted moieties with a crosslinker; and
c) simultaneously protonating the deprotonated moieties at the ends with proton donors, and covalently crosslinking the reacted moieties at the ends in order for the 2D materials of step b) to interact with each other to form the nanofiber;
wherein the crosslinker is a polyfunctional crosslinker.

In some embodiments, the method of forming a nanofiber, comprises:
a) providing 2D materials with cationic or anionic moieties on its planar surfaces and at its ends; and
b) reacting the cationic or anionic moieties on the planar surfaces with at least partially hydrophobic counterions in order to curl the 2D material, and
c) simultaneously reacting the cationic or anionic moieties at the ends with at least partially hydrophobic counterions and ionically crosslinking the reacted charge bearing moieties at the ends in order for the 2D materials of step b) to interact with each other to form the nanofiber.

The method of forming a nanofiber can be performed in an aqueous medium.

In some embodiments, the cationic or anionic moieties are electrostatically bonded to the 2D materials. In other embodiments, the cationic or anionic moieties are ionically bonded to the 2D materials. This type of chemical bonding involves the electrostatic attraction between oppositely charge bearing moieties.

In some embodiments, a ratio of 2D materials to the cationic or anionic moieties is about 1:30 to about 1:80. In other embodiments, the ratio is about 1:30 to about 1:70, about 1:30 to about 1:60, about 1:40 to about 1:60, or about 1:50 to about 1:60. In some embodiments, a ratio of 2D materials to the cationic or anionic moieties is about 1:50.

Advantageously, the excess ionic moieties that do not adsorb onto the 2D materials surfaces stay in solution and can be reused in a new batch.

In some embodiments, the cationic or anionic moieties are organic cationic or anionic moieties. In other embodiments, the cationic or anionic moiety is selected from sulfonimide, imidazolium, pyridinium, piperidinium, ammonium, phosphonium, imide, sulfonate, sulphate, borate, phosphate, carboxylate or their derivative thereof. In some embodiments, the cationic or anionic moiety is bis(trifluoromethane)sulfonimide. In some embodiments, the anionic moiety is provided as a salt selected from lithium bis(trifluoromethane)sulfonimide.

In some embodiments, the charge bearing moieties are reacted with counterions having an opposite charge relative to the cationic or anionic moieties on the 2D material. The counterions are at least partially hydrophobic.

In some embodiments, the counterions are organic counterions. In other embodiments, the counterion is selected from imidazolium, pyridinium, piperidinium, ammonium, phosphonium, imide, sulfonate, sulphate, borate, phosphate, carboxylate or their derivative thereof. In some embodiments, the counterion is 1-butyl-3-methylimidazolium. In some embodiments, the counterion is provided by a salt selected from 1-butyl-3-methylimidazolium methanesulfonate.

In some embodiments, step b) further comprises ionically crosslinking the reacted cationic or anionic moieties on the planar surfaces. The crosslinking agent can be the same as that in step c). The crosslinking agent can be the at least partially hydrophobic counterions.

In some embodiments, step b) and step c) are performed under ultrasonication or stirring. In some embodiments, at least step b) is performed under ultrasonication or stirring.

In some embodiments, the ultrasonication or stirring is performed for at least 10 min at about 3° C. to about 10° C., or about 10° C. In other embodiments, the duration is for at least about 15 min, or about 20 min. In some embodiments, the ultrasonication or stirring is for at least about 30 min at about 0° C. to about 10° C.

In some embodiments, the method further comprises a step of functionalising 2D materials with cationic or anionic moieties in order to form the 2D materials with cationic or anionic moieties of step a).

In some embodiments, the step of functionalising 2D materials with cationic or anionic moieties is performed under ultrasonication in the presence of cationic or anionic moieties.

In some embodiments, the ultrasonication is performed for at least 10 min at about 3° C. to about 10° C., or about 10° C. In other embodiments, the duration is for at least about 15 min, or about 20 min. In some embodiments, the ultrasonication is for at least about 30 min at about 3° C. to about 10° C., or about 10° C.

In some embodiments, when the 2D material is graphene, the method further comprises a step before step a) of exfoliating graphite in the presence of the cationic or anionic moieties.

In some embodiments, when the 2D material is hexagonal boron nitride, the method further comprises a step before step a) of exfoliating non-delaminated hexagonal boron nitride in the presence of the cationic or anionic moieties.

In some embodiments, the graphite or non-delaminated hexagonal boron nitride and the cationic or anionic moieties are dispersed in an aqueous medium and organic medium mixture in a ratio of about 95:5.

In some embodiments, the exfoliation step is performed under high power probe ultrasonication.

The method can also be applied to a combination of 2D materials to form heterostructured nanofibers. For example, a self-assembly process of 2D electrolytes and 2D confined electrolytes can be applied. Different 2D materials can be functionalised with various ionisable functional groups of opposite charge. For example, graphene oxide (GO) can be functionalised with cationic group (—NH₃⁺) and molybdenum disulfide (MoS₂) with anionic group (COO⁻), to allow ionic interaction between the oppositely charged nanomaterials. Comparatively to the 2D electrolytes and 2D confined electrolytes fiber formation as disclosed herein, instead of charge inversion, these nanofibers are formed by the attractive interaction between both 2D material sheets in the confined aqueous environment. The charge compensation makes these materials less stable in the water medium and coagulation into nanofibers composed of both materials. The application of sonication process allows both materials to overcome the energy barrier and continuously assemble and scroll into fibers. As the reaction proceed, long fiber bundles with branches are formed. This method offers a facile approach for the scale-up synthesis of heterostructured nanofibers with low production cost.

In some embodiments, the method of forming a nanofiber in an aqueous medium, comprises:
a) providing 2D materials with cationic or anionic moieties on its planar surfaces and at its ends; and
b) reacting the cationic or anionic moieties on the planar surfaces with another 2D materials with oppositely charge bearing moieties on its planar surfaces and at its ends in order to curl the 2D material, and
c) simultaneously reacting the cationic or anionic moieties at the ends with the another 2D materials with oppositely charge bearing moieties on its planar surfaces and at its ends and ionically crosslinking the reacted charge bearing moieties at the ends in order for the 2D materials of step b) to interact with each other to form the nanofiber.

In some embodiments, when the 2D materials comprises positively charge bearing moieties on its planar surfaces and at its ends, the 2D materials with oppositely charge bearing moieties on its planar surfaces and at its ends comprises negatively charge bearing moieties. In some embodiments, when the 2D materials comprises negatively charge bearing moieties on its planar surfaces and at its ends, the 2D materials with oppositely charge bearing moieties on its planar surfaces and at its ends comprises positively charge bearing moieties.

In some embodiments, the 2D material with oppositely charge bearing moieties is selected from graphene, graphene oxide, few-layer transition-metal dichalcogenides, hexagonal boron nitride or a combination thereof. In other embodiments, the 2D material is selected from graphene, graphene oxide, reduced graphene oxide, and few-layer transition-metal dichalcogenides, hexagonal boron nitride or a combination thereof.

In some embodiments, the 2D materials with oppositely charge bearing moieties is at least about 50% functionalised with the charge bearing moieties. In other embodiments, the 2D materials is at least about 55%, about 60%, about 65%, about 70%, about 75%, about 80%, about 85%, about 90%, or about 90% functionalised with the charge bearing moieties. In other embodiments, the 2D materials is functionalised about 50% to about 90%, about 60% to about 90%, about 70% to about 90%, or about 80% to about 90%. The functionalisation can be estimated using x-ray photoelectron spectroscopy (XPS).

In some embodiments, the 2D materials are graphene oxide functionalised with cationic moieties and the another 2D materials are molybdenum disulfide (MoS₂) functionalised with anionic moieties. In other embodiments, the graphene oxide is functionalised with —NH₃⁺ moieties and MoS₂ is functionalised with —COO⁻ moieties.

In some embodiments, a weight ratio of the 2D materials relative to the another 2D materials is about 1:1, 1:2, and 1:3.

In some embodiments, the 2D materials and/or the another 2D materials are provided at a concentration of about 0.01 mg/mL to about 1 mg/mL. In other embodiments, the concentration is about 0.01 mg/mL to about 0.9 mg/mL, about 0.01 mg/mL to about 0.8 mg/mL, about 0.01 mg/mL to about 0.7 mg/mL, about 0.01 mg/mL to about 0.6 mg/mL, about 0.01 mg/mL to about 0.5 mg/mL, about 0.01 mg/mL to about 0.4 mg/mL, about 0.01 mg/mL to about 0.3 mg/mL, about 0.01 mg/mL to about 0.2 mg/mL, or about 0.01 mg/mL to about 0.1 mg/mL. In other embodiments, the concentration is about 0.05 mg/mL.

In some embodiments, the method comprises reacting the 2D materials with the another 2D materials in a flow reactor.

The present invention also provides a nanofiber, wherein the nanofiber is characterised by a solid or semi-hollow cross sectional profile; wherein the nanofiber is characterised by a layered cross sectional profile of 2D materials curled up and bonded to each other at their planar surfaces and ends; and wherein the 2D materials are selected from graphene, graphene oxide, few-layer transition-metal dichalcogenides, hexagonal boron nitride or a combination thereof.

If the ionic method is used, the nanofibers are not completely solid, i.e., there is a gap or spacing at the inner axial line (similar to a center of a scrolled or rolled up parchment). It is believed that this longitudinal axis is stabilized by the alkyl chain of the imidazolium salt or residual “free” salt, and thus not really hollow or not comprising free space. If the covalent method is used, it is believed that this space is filled by the organic phase formed by the crosslinker (amino compound).

In some embodiments, the nanofiber is characterised by a diameter of about 5 nm to about 400 nm. In other embodiments, the diameter is about 5 nm to about 350 nm, about 5 nm to about 300 nm, about 5 nm to about 250 nm, about 5 nm to about 200 nm, about 5 nm to about 190 nm, about 5 nm to about 180 nm, about 5 nm to about 170 nm, about 5 nm to about 160 nm, about 5 nm to about 150 nm, about 5 nm to about 140 nm, about 5 nm to about 130 nm, about 5 nm to about 120 nm, about 5 nm to about 110 nm, or about 5 nm to about 100 nm. In some embodiments, the nanofiber is characterised by a diameter of about 10 nm to about 100 nm.

In some embodiments, the diameter is inhomogeneous. In this regard, the diameter is not fixed throughout the length of the nanofiber, but rather varies along its length. This is a result of the stacking of different amounts of 2D materials along the length of the nanofiber.

In some embodiments, the nanofiber is characterised by a length of about 5 μm to about 100 μm. In other embodiments, the length is about 5 μm to about 90 μm, about 5 μm to about 80 μm, about 5 μm to about 70 μm, about 5 μm to about 60 μm, about 5 μm to about 50 μm, about 5 μm to about 45 μm, about 5 μm to about 40 μm, about 5 μm to about 35 μm, about 5 μm to about 30 μm, about 6 μm to about 30 μm, about 7 μm to about 30 μm, about 8 μm to about 30 μm, about 9 μm to about 30 μm, about 10 μm to about 30 μm, about 12 μm to about 30 μm, about 14 μm to about 30 μm, or about 16 μm to about 30 μm. In some embodiments, the nanofiber is characterised by a length of about 10 μm to about 30 μm.

In some embodiments, the nanofiber is characterised by an aspect ratio of about 30 to about 3000. In other embodiments, the aspect ratio is about 30 to about 2800, about 30 to about 2600, about 30 to about 2400, about 30 to about 2200, about 30 to about 2000, about 30 to about 1800, about 30 to about 1600, about 30 to about 1400, about 30 to about 1200, about 30 to about 1000, about 50 to about 1000, about 100 to about 1000, about 200 to about 1000, about 300 to about 1000, about 400 to about 1000, about 500 to about 1000, about 600 to about 1000, about 700 to about 1000, or about 800 to about 1000.

The systems behave similarly to a “living polymerization system”, where the limitations for the nanofibers to keep growing are the building block feeding (in this case functionalized 2D materials) and the fibers (meta)stability in the medium. The fibers will keep growing as long as properly modified 2D materials are added until they reach a threshold that the fibers are too long to be (partially)stable in the medium and will be fully phase separated (and stop growing).

In some embodiments, the nanofiber is semicrystalline. In this regard, the nanofiber has both crystalline and amorphous characteristics. The semicrystalline property can be due to the spatial orientation of the 2D materials when they bond to each other to form the nanofiber. The degree of crystallinity can be estimated by different analytical methods such as calorimetry, X-ray diffraction, raman spectroscopy and NMR. In some embodiments, the nanofiber has a degree of crystallinity of about 10% to about 90%, about 10% to about 85%, about 10% to about 80%, about 10% to about 75%, about 10% to about 70%, about 10% to about 65%, about 10% to about 60%, about 10% to about 55%, about 10% to about 50%, about 10% to about 45%, about 10% to about 40%, about 10% to about 35%, about 10% to about 30%, about 10% to about 25%, or about 10% to about 20%.

In some embodiments, when the nanofiber is a graphene nanofiber, the nanofiber is characterised by an interlayer spacing of about 0.40 nm to 0.45 nm. In other embodiments, the interlayer spacing is about 0.40 nm to 0.44 nm, about 0.40 nm to 0.43 nm, about 0.40 nm to 0.42 nm, or about 0.40 nm to 0.41 nm. In some embodiments, when the nanofiber is a graphene nanofiber, the nanofiber is characterised by an interlayer spacing of about 0.40 nm to 0.43 nm.

In some embodiments, when the nanofiber is a graphene nanofiber, the nanofiber is characterised by amide bonds. In some embodiments, when the nanofiber is a graphene nanofiber crosslinked by amide moieties, the nanofiber is characterised by an X-ray photoelectron spectroscopy peak at about 288 eV to about 290 eV. In some embodiments, when the nanofiber is a graphene nanofiber crosslinked by amide moieties, the nanofiber is characterised by FTIR peaks at about 1653 cm⁻¹ and about 1572 cm⁻¹.

In some embodiments, when the nanofiber is a heterogeneous nanofiber comprising graphene oxide and MoS₂, the nanofiber is characterised by a Raman band at about 1350 cm⁻¹. In other embodiments, the nanofiber is characterised by a Raman band at about 1660 cm⁻¹. In other embodiments, the nanofiber is characterised by a Raman band at about 380 cm⁻¹. In other embodiments, the nanofiber is characterised by a Raman band at about 410 cm⁻¹.

### EXAMPLES

### Graphene Nanofibers

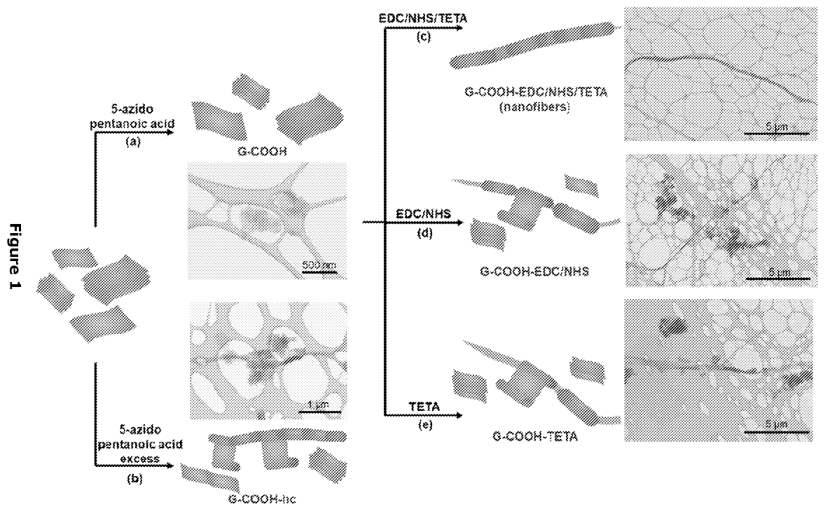

To obtain 2D-electrolytes and assembly them into cross-linked nanofibers, graphene platelets are initially functionalized using 5-azidopentanoic acid via decomposition of azide. Depending on the azide molecules/graphene ratio, different functionalization degrees and morphological structures are observed. Specifically, an excess of 5-azidopentanoic acid molecules (G-COOH-higher concentration—G-COOH-hc) leads to a controlled aggregation process, which is resultant from the formation of fiber-like structures (FIG. 1b). This type of structure is rarely observed for lower degree of functionalization (G-COOH) (FIG. 1a).

G-COOH is further functionalized with a polyfunctional molecule, namely triethylenetetramine (TETA), by reacting with the carboxylic groups previously activated with EDC/NHS. The initial pH of the G-COOH suspension is adjusted to acidic range, which favours the scrolling or curling process of the functionalized graphene sheets. Interestingly, the majority of the resulting structures are highly branched nanofibers with high aspect ratio, which entwine along each other (FIG. 1c and FIG. 13). The diameters are in the range between 10 and 100 nm, whereas lengths exceed 10 μm (FIG. 13). This system is referred here as nanofibers. It is noteworthy that highly branched structures can act as gas adsorbents and/or anchor other types of molecules and structures, such as metallic nanoparticles.

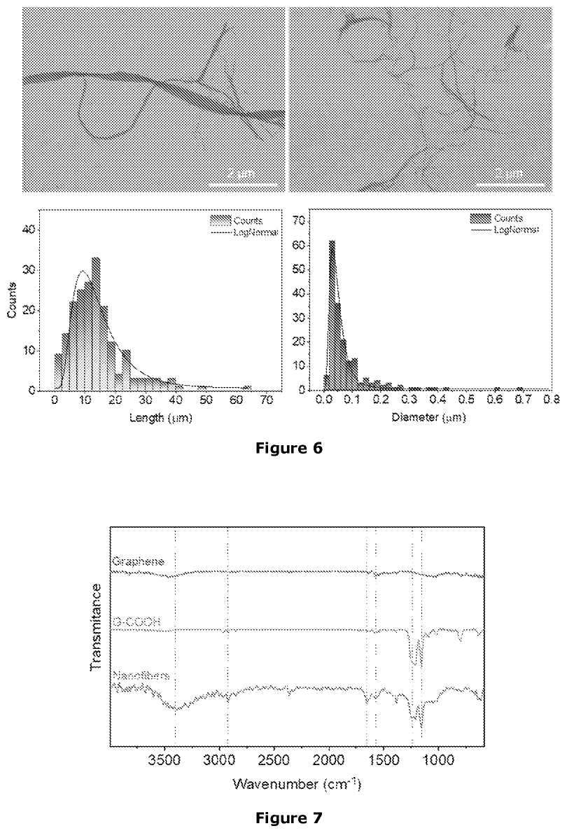

FIG. 1 summarizes the fiber formation process. After the reaction with EDC/NHS/TETA, the majority of the resulting structures are highly branched nanofibers with high aspect ratio. The diameters are in the range between 10 and 100 nm, whereas lengths exceed 10 μm (FIG. 6). This system is referred here as nanofibers. It is noteworthy that highly branched structures can act as gas adsorbents and/or anchor other types of molecules and structures, such as metallic nanoparticles.

To clarify the assembly mechanism of 2D structures, two control experiments are performed: (i) using exclusively EDC/NHS (G-COOH-EDC/NHS) (FIG. 1d), and (ii) using solely TETA (G-COOH-TETA) (FIG. 1e). The remaining parameters are reserved. Fiber-like structures were observed in both cases, however in a lower yield compared to the system with EDC/NHS and TETA applied together (nanofibers).

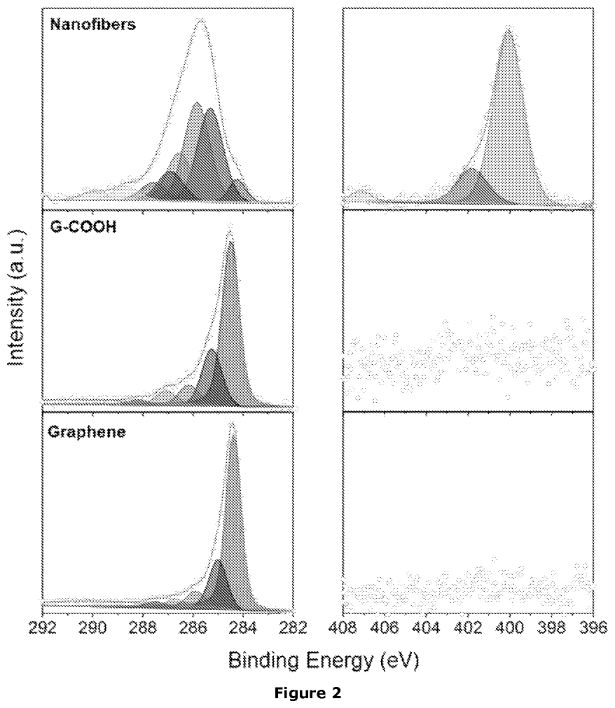

The elemental composition of the systems is analyzed and compared step-by-step via X-ray photoelectron spectroscopy (XPS) (FIG. 2). The positions and percentages of the deconvoluted peaks for C1s spectra are summarized in Table 1. Deconvolution of the C1s peak shows five main peaks: C═C at 284.4 eV, hydroxyl (C—O) at 285.9 eV, epoxy/ether (C—O—C) at 286.7 eV, carbonyl (C═O) at 287.5 eV, and carboxylate (O—C═O) at 288.4 eV.

TABLE 1
Binding energy of the deconvoluted C1s XPS peaks and their relative percentage area (in parentheses).

| | C═C | C—C | C—O/C—N | C═O | N—C═O | HO—C═O | | |
|---|---|---|---|---|---|---|---|---|
| Graphene | 284.38 | 285.00 | 285.90 | 286.70 | | 287.52 | | |
| | (70.%) | (19.1%) | (6.2%) | (2.9%) | | (1.8%) | | |
| G-COOH | 284.49 | 285.25 | 286.17 | 287.06 | | 288.19 | | |
| | (63.0%) | (21.8%) | (7.7%) | (5.5%) | | (2.0%) | | |
| Nanofibers | 284.23 | 285.31 | 285.84 | 286.55 | 286.90 | 287.58 | 288.68 | 290.01 |
| | (5.4%) | (28.5%) | (30.2%) | (14.6%) | (8.9%) | (5.5%) | (4.4%) | (2.5%) |
| G-COOH-hc | 284.79 | 285.57 | 286.09 | 286.79 | | 287.70 | 289.04 | 290.03 |
| | (6.9%) | (38.5%) | (33.7%) | (11.0%) | | (4.0%) | (3.9%) | (1.9%) |
| G-COOH-EDC/NHS | 284.85 | 285.90 | 286.43 | 287.33 | | 288.37 | 289.47 | 290.31 |
| | (3.7%) | (49.8%) | (23.9%) | (6.7%) | | (1.6%) | (11.1%) | (3.3%) |
| G-COOH-TETA | 284.80 | 285.99 | 286.63 | 287.61 | | 288.86 | 289.81 | 290.54 |
| | (3.3%) | (39.0%) | (26.4%) | (7.8%) | | (3.9%) | (13.4%) | (6.2%) |

A slight relative increase of the sp3 and O-containing groups are observed for G-COOH with lower degree of functionalization, which are further increased after the reaction with EDC/NHS/TETA, with subsequent nanofiber formation (FIG. 2). It is important to note that the relative increase of the peaks around 288-289 eV can be related to the crosslinking reactions between graphene sheets, resulting in amide functional groups, as we will discuss shortly. The relative increase of the peaks at 1653 and 1572 cm⁻¹ in the FTIR spectra (FIG. 7), attributed to amide I (C═O stretching vibration) and amide II (N—H bending vibration), respectively, corroborates the formation of amide groups after the reaction. The reaction with EDC/NHS/TETA leads to an expected relative increase in the total percentage of N due to the presence of TETA molecules. Two main peaks could be deconvoluted: amide (—NH—(C═O)—) or secondary/tertiary amine at 400.3 eV and protonated amine (NH₃O from TETA at 401.9 eV.

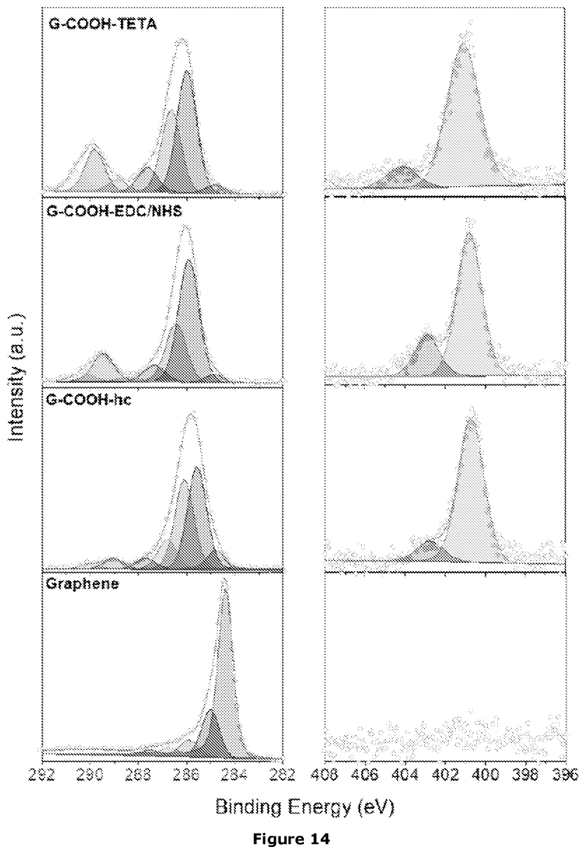

FIG. 14 shows the C1s and N1s high resolution XPS spectra for other derivations of the reaction previously shown in FIG. 1. The graphene spectrum was repeated to facilitate the comparison between the spectra. When an excess of 5-azidopentanoic acid (G-COOH-hc) is utilized, a higher degree of functionalization is achieved in comparison to G-COOH (FIG. 2). The alignment of the graphene flakes and formation of fiber-like structures may arise from the intermolecular reaction between free azido molecules and the carboxylic acid attached to the graphene structure, resulting in a cross-linking process. For the controls, G-COOH-EDC/NHS and G-COOH-TETA, a relative increase of the peaks is observed in the region related to amide and carboxylic/ester groups, suggesting the formation of cross-linking reactions. Additionally, for G-COOH-TETA, the broadening of the N1s peaks indicates a larger presence of primary amine groups, which is expected due the presence of TETA molecules.

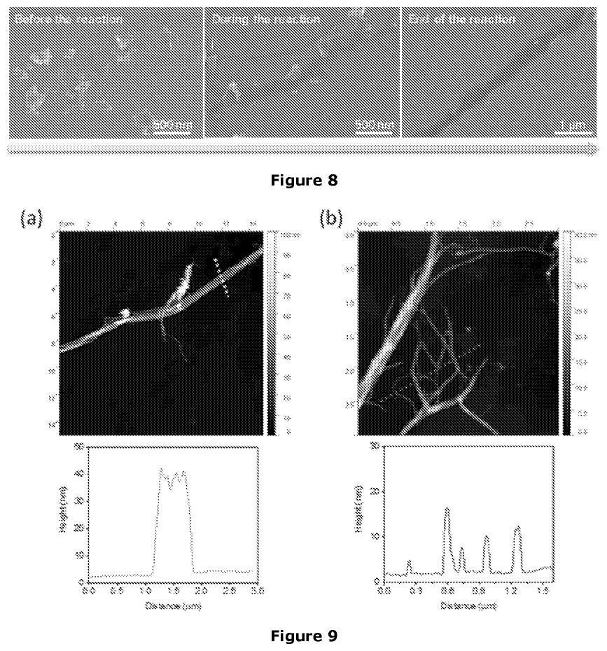

It was observed that the reaction can continue until all small graphene platelets are consumed. FIG. 8 shows representative SEM images at different stages at pH˜6.5. The small platelets continue to react and self-assemble into the pre-existent nanofibres, which results in longer and thicker structures.

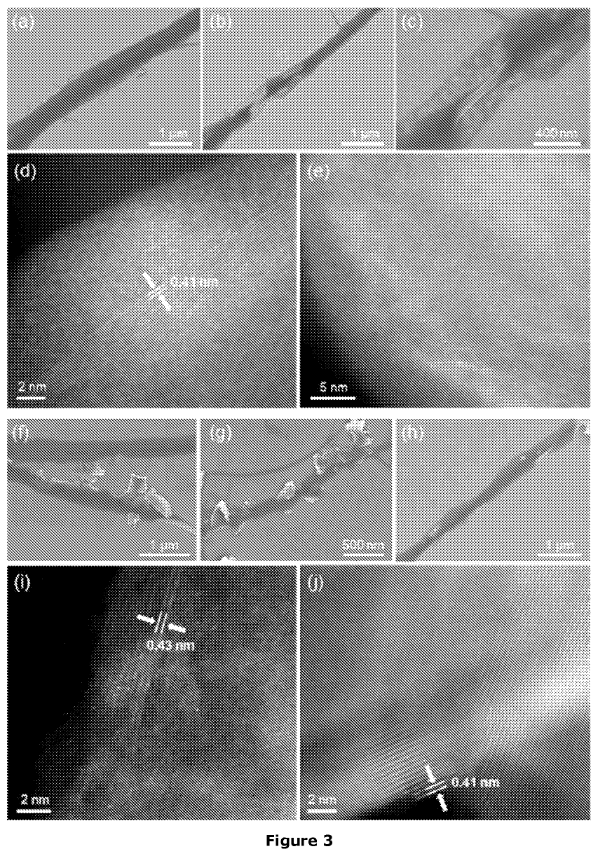

A closer examination on the nanofibers with SEM reveals the formation of two different types of structures (FIG. 3): (i) one highly resistant, and (ii) another less resistant to the e-beam (FIG. 3a,b,c). At the same time, some nanofibers are resistant to the e-beam (FIGS. 3f,g,h), indicating the self-assembly of the functionalized graphene sheets on the nanofibers surface. Moreover, according to our observations, this reaction continues until complete consumption of the graphene platelets. If the reaction has not been finished, “free” platelets maintain a continuous reaction and self-assembly onto the pre-existent fibers, resulting in longer and thicker structures as a function of time, indicating spontaneous crosslinking and living polymerization. Electrostatic interactions may also contribute for the assembling process.

The images obtained by High Resolution Scanning Electron Transmission Electron Microscopy (HR-STEM) reveal different locations of the crystalline part formed by graphene sheets at the center (FIGS. 3d,e) or on the surface of the fiber (FIGS. 3i,j). Therefore, in FIGS. 3a,b,c, the high contrast region is constituted primarily of functionalized graphene sheets, thus implying its high stability under the e-beam, while the dark part is composed by an amorphous organic phase formed by the reactants (EDC/NHS/TETA).

An interlayer spacing ranging from 0.40 nm to 0.43 nm is observed, slightly larger than that of graphite (0.34 nm), and approximately the same as scrolls formed by 2D electrolytes. This result is expected considering the incorporation of functional groups onto the graphene surface. Importantly, neither the crystalline nor the amorphous phases are completely homogeneous along the nanofiber. Additionally, fibers with diameters below 10 nm did not present obvious crystalline phase.

This semicrystalline behaviour agrees with the non-uniform structure observed in the AFM images (FIG. 9), showing a non-uniform organization, which results from the random layer combination. Moreover, the diameter of the structures is not uniform along the fiber.

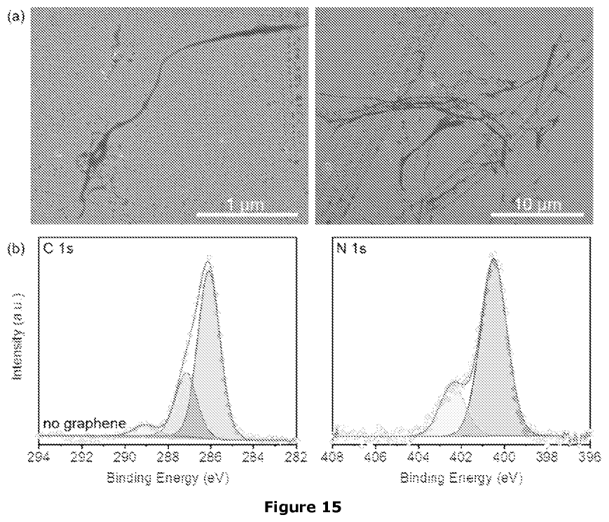

Bare EDC/NHS/TETA systems (without the charge bearing moieties) were also prepared, as reference, by keeping the same experimental steps of the reaction. Fiber-like structures were observed for such systems; however, they are randomly interconnected and resemble more a network with low crosslinking density (FIG. 15a), suggesting a partially independent network formation.

From the high resolution C1s and N1s XPS spectra (FIG. 15b), when the G-COOH is absent, the peaks are attributed to groups, such as C—O, C—N and C═O. As in previous samples, for the N1s region, two main peaks can be deconvoluted, namely amide or amine (secondary and tertiary) at 400.3 eV, and protonated amine (NH₃⁺) at around 402 eV, both originating from TETA and EDC. In the absence of G-COOH, the latter presents relative higher intensity and a slight shift when compared to the nanofibers, which is associated to a higher concentration of protonated amine. These findings suggest that an organic fiber network is simultaneously formed, but in an organized fashion since it involves the G-COOH building blocks in the scrolled form of this 2D-electrolyte.

The Raman spectra (FIG. 4) show the typical bands of carbon structures (D, G and 2D bands) along the nanofiber structure (FIG. 4a), with the relative intensity of the Raman bands varying as a function of the position along the fiber. The D band, associated with defects and deformations, is much more pronounced in the positions close to the edges of the filaments, at the intersections, or on the shorter structures. In the latter, it is difficult to separate the signal from the edge or the middle of the fiber since the laser spot (1-2 μm) is larger than the filament diameter. This variation in the relative intensity of the Raman bands along a single structure has also been reported for CNTs, and the enhanced D band in scrolls-like structures has been attributed to the curvature-induced disorder. To better understand the distribution of the graphene within the nanofibers, Raman mappings are performed (FIG. 4b), showing that the nanofibers are indeed inhomogeneous. However, D, G and 2D bands are prevalent along the structure, indicating the successful construction of the hybrid nanofiber by self-assembly approach. The Raman mappings for other systems shows that G-COOH-hc, G-COOH-EDC/NHS and G-COOH-TETA also presented D, G and 2D bands, but with varying degrees of discontinuity along the nanofibers. Moreover, these systems presented many ‘free’ graphene flakes, i.e., unattached to the nanofibers. As expected, for the system without graphene, no characteristic D, G or 2D peaks were detected.

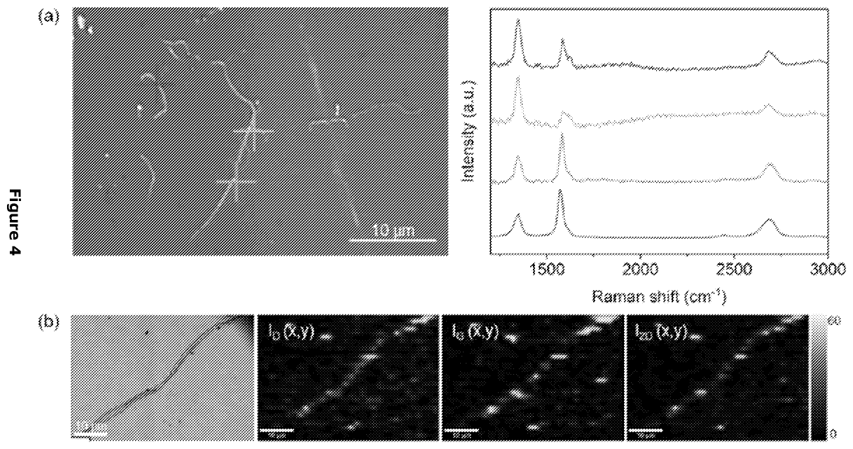

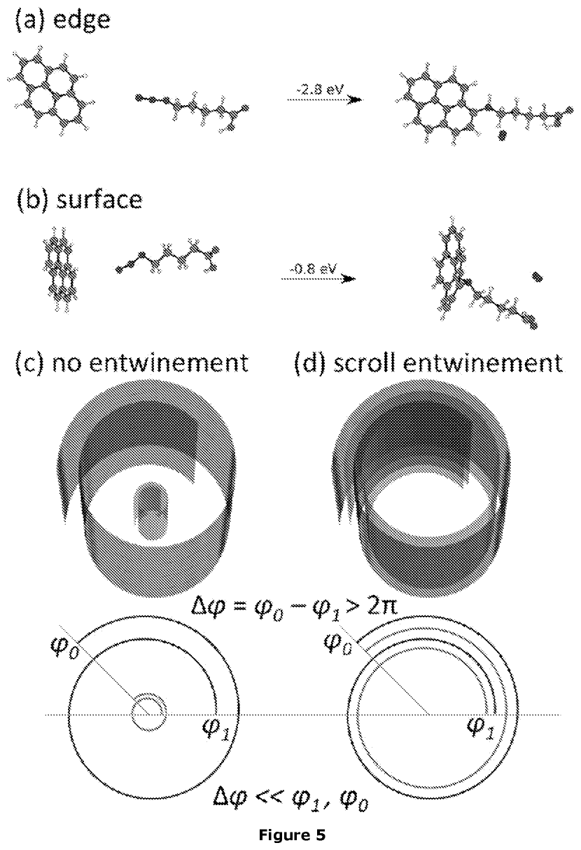

The underlying mechanism for formation of such structures is further investigated theoretically. We find that the functional groups are concentrated at the graphene edges after functionalization with 5-azidopentanoic acid as seen in the computer simulations (FIGS. 5a,b). The zig-zag sites in the graphene structure are reactive and enable carbene related reactions, including cyclo-addition. Moreover, the oxygen-containing groups on graphene surface, resultant from liquid phase exfoliation process are concentrated mostly at the edges, and can react with the azido molecules. FIGS. 5(a,b) demonstrate that the edge functional groups link graphene platelets with higher binding energy than the surface functional groups. Consequently, one can observe an efficient regioselectivity of the subsequent reaction steps, allowing the reaction to continue predominantly at the edges, providing a preferential longitudinal fiber growth.

Taking into consideration the steps represented in FIG. 1, we simulate cross-linking reactions that are most likely to occur. As one can observe, all mechanisms have similar energies (within <0.4 eV) and may explain not only the nanofiber formation, but also the incorporation of the G-COOH into or onto the nanofibers. The activation of the carboxylic groups on G-COOH by EDC/NHS and the polyfunctional character of the amine molecule (TETA) can result in the assembly of the graphene sheets, leading to the formation of large 1D-structures. However, we have observed experimentally, from the “control” reactions, and confirmed by the computer simulations, that multiple mechanisms can occur simultaneously.

Moreover, two random scrolls are only able to form a self-assembled structure between them if they are constituted of platelets with similar sizes; the regular layered structure is not possible otherwise. The model explaining this effect is shown in FIG. 5(c,d). The scrolls are Archimedean spirals described by (φ)=φd/2π, where r is the radius-vector, φ is the azimuthal angle and d is the interlayer distance. The scroll shape is determined by balancing the elastic energy trying to flatten the scroll and the interlayer interaction. The Archimedean scrolls made of the same material have the same shape determined solely by material constants, (bending stiffness) and H (Hamaker constant). The scrolls are then similar in geometrical sense, i.e. they can be described by the same pairs of angles φ0 and φ1 no matter how large the original platelets are, see FIG. 5(c,d). If φ0−φ1«φ0, φ1, then one can write the ratio L/d˜φc, where L=2πrc is the linear size of square-shaped platelets, rc is the characteristic scroll radius, and φc is given by φc=2π√6πD/H. For the scrolls to entwine in a regular manner the difference between their characteristic radii should be of the same order as the interlayer distance of the larger specimen, i.e. Δrc˜d. Since Δrc=ΔL/2π and d˜L/φc we can write the following condition for regular scroll entwinement:

$$\frac{Δ L}{L} \sqrt{\frac{6 π D}{H}} \sim 1 , \qquad ( 1 )$$

where ΔL should be seen as the standard deviation in the linear size distribution of platelets. If ΔL is large, then two random platelets most likely have large difference in sizes that hampers fiber formation. Equation (1) also suggests that the situation becomes more challenging for scroll/fiber formation if D»H (the case of pristine graphene with D of about 1 eV). Graphene functionalization usually reduces the bending stiffness by orders of magnitude (D=0.025 eV for graphene oxide). This should also be the case for our functionalization technique. We expect D˜H and ΔL˜L for our graphene which facilitates scroll entwinement and fiber growth.

Altogether, the experimental evidence suggest that an interface-confined polymerization reaction is happening on the G-COOH structures. The chemical environment produced by the reaction leads to a scrolling process of G-COOH. Since G-COOH structure presents carboxylic groups on both sides of the sheets, further polymerization occurs on the other part of the scroll structures, forming a layered fibrous structure. This structure is guided by an organic fibrous network that is simultaneously formed by the crosslinking reactions among EDC/NHS/TETA molecules used for functionalization. Moreover, these reactions take place mostly at the scroll/fiber edges due to both the higher regioselective reactivity and the high structural anisotropy of the system, justifying the high aspect ratio obtained. Interestingly, one can observe that the fibers are continuously growing over time via self-assembly and reactions owing to the greater availability of functional groups at the edges, suggesting a living polymerization profile.

2D-Confined Electrolytes Assembly into Nanofibers

The preparation of graphene nanofibers, that are ionically crosslinked, can be achieved both (i) directly from graphene modification with organic salts or (ii) via exfoliation of graphite into graphene in the presence of the salts. In the two referred approaches, only the first step differs and it is described as follows:
1. When using graphene, a water dispersion containing one (1) part of graphene to fifty (50) parts of a salt with a partially hydrophobic organic anion and a hydrophilic inorganic cation, e.g. bis(trifluoromethane)sulfonimide lithium (LiNTf₂), is prepared. Ideally, the graphene concentration is kept around 0.5 mg/mL and the dispersion is sonicated for 20 min at 10° C. (bath sonication). The dispersion is centrifuged at 6000 rpm for 15 min and the supernatant is filtered and washed with water. The residual water containing only the salt (LiNTf₂) can be reused in new batches.
2. When using graphite, a water/organic solvent (95/5) dispersion containing one (1) part of graphite to fifty (50) parts of a salt with a partly hydrophobic organic anion and a hydrophilic inorganic cation, e.g. LiNTf₂, is prepared. The organic solvent must phase separate with water (e.g. dichloromethane or chloroform), forming a metastable emulsion when under ultrasound. Ideally, the graphite concentration is kept around 0.5 mg/mL and the dispersion is submitted to 30 min (split in 3 session of 10 min) of high power probe ultrasound (20 kHz, 2000 W) at ˜10° C. The emulsion formed is centrifuged at 6000 rpm for 15 min and the supernatant is filtered and washed with water. The residual water containing only (LiNTf₂) can be reused in new batches.

For both approaches, the filtered and washed resulting material is redispersed in water and the new dispersion is then submitted to intensive stirring, and an equimolar amount (in relation to LiNTf₂ previously applied) of a salt with an organic and partially hydrophobic cation dissolved in water, e.g. 1-butyl-3-methylimidazolium methanesulfonate (BMImMes), is added dropwise to the dispersion and left stirring for 1 hour. Then, the mixture is submitted to 10 min of ultrasound (bath ultrasound, 10° C.) and left resting for 10 min. The initially transparent dispersion starts to become turbid and fibrillar growth is observed. The resulting mixture is left resting in the fridge (˜5° C.) overnight. The resulting fibers are filtered and washed with water.

The same protocol described above for graphite/graphene can be applied to many other 2D materials by only selecting the appropriate salts to interact with them during the fibrillation process. Moreover, the exact same protocol and salts used can be applied to 2D materials such as hexagonal boron nitride (hBN), as will be shown below.

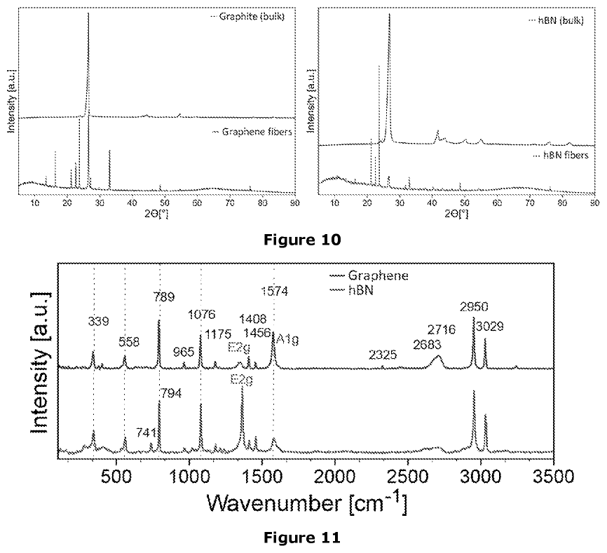

The XRD patterns of bulk samples and the samples after fiber formation are shown in FIG. 10. Typical diffraction lines are observed for graphite and hBN structures. Concretely, diffraction lines of (002) at 26.46°, (100) at 44.38°, (004) at 54.65° and (110) at 77.44° for graphite; and (002) at 26.86°, (100) at 41.78°, (101) at 43.77° and (004) at 55.14° for (bulk) hBN. The remaining diffraction lines which are seen in all diffraction patterns of modified samples correspond to the incorporated salt. The most intensive diffraction lines are placed at 21.19, 22.56 and 23.69° corresponding to d-spacing 0.419, 0.394 and 0.376 nm.

Raman spectra of modified graphene and hBN-based fibers are shown in FIG. 11.

The vibration modes of exfoliated materials are marked as E2g at 1343 cm⁻¹ (G band) and A1g at 1574 cm⁻¹ (D band) for graphite; and E2g at 1359 cm⁻¹ for hBN. The vibration bands characteristic for the salt (BMImMes) are all presented without significant shifts. The presence of the 1-butyl-3-methylimidazolium cation corresponds the vibration band vₐₛ(C—H) at 3029 cm⁻¹, vₛ(C—H) at 2950 cm⁻¹, v (C—C) at 1574 cm⁻¹, 1408 cm⁻¹ and 1456 cm⁻¹, δ(C—H) at 1343 cm⁻¹ and imidazolium ring breathing vibration at 965 cm⁻¹. The bis(trifluoromethylsulfonyl)imide anion is confirmed by presence of vibration modes vₐₛ(S—N) and vₛ(C—F) at 789 cm⁻¹, δₛ(CF₃) at 741 cm⁻¹, δₛ(SO₂) at 558 cm⁻¹ and τ(SO₂) at 339 cm⁻¹.

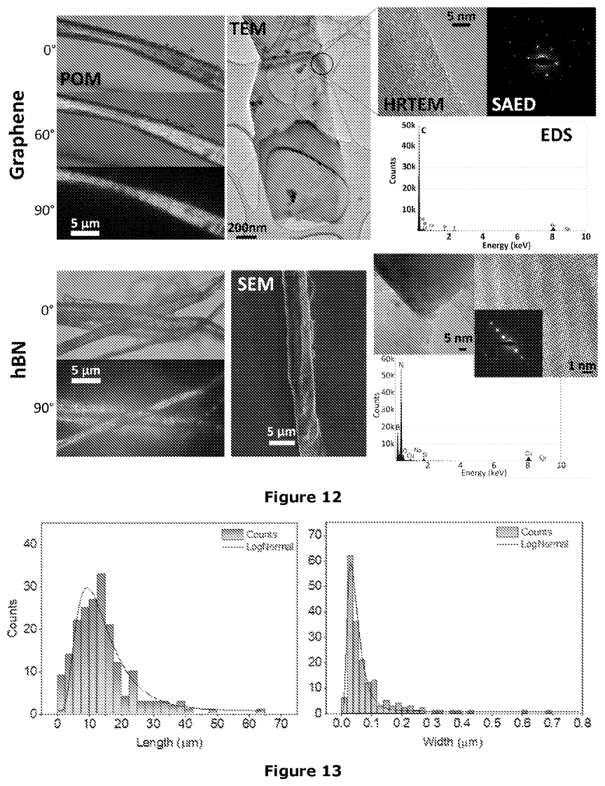

Polarized light optical microscopy (POM, with a single polarizer and cross-polarized), scanning (SEM) and transmission electron microscopy in low (TEM) and high resolution (HRTEM) are used to demonstrate the fibers structural order, as well as their elemental distribution (using energy dispersive spectroscopy, EDS) and crystallinity (using selected area electron diffraction, SAED), and are shown in FIG. 12. The POM images show highly ordered fiber structures composed of scrolled 2D sheets (graphene or hBN), and their cross-polarized images demonstrates a defined birefringence effect. SEM and TEM images show that both graphene and hBN were able to form very long semi-hollow fibers, and HRTEM of their edges demonstrate the characteristic arrangement of scrolled 2D sheets. The EDS elemental distribution of the fibers confirms the dominant carbon composition for graphene fibers, and boron and nitrogen composition for hBN. Moreover, HRTEM and SAED demonstrate that most of the original crystallinity of graphene and hBN is kept throughout the fibrillation process and there is some directionality of the electron diffraction in the direction where the sheets are bending to scroll into fibers, as expected for bent crystals.

Altogether, we demonstrated two versatile, facile and unique approaches for obtaining fibers from small graphene flakes through self-assembly. All the steps are performed in suspension and most of them in water and at room temperature, which can speed the scale up process and large scale production. The resulting fibers present a high aspect ratio and diameters at nanoscale. Such structures are relevant for a great variety of applications, including smart electronic fibrous devices, textiles, flexible and wearable electronics, sensors, membranes for filtration, batteries and supercapacitors.

### Self-assembled Heterostructure Fibers

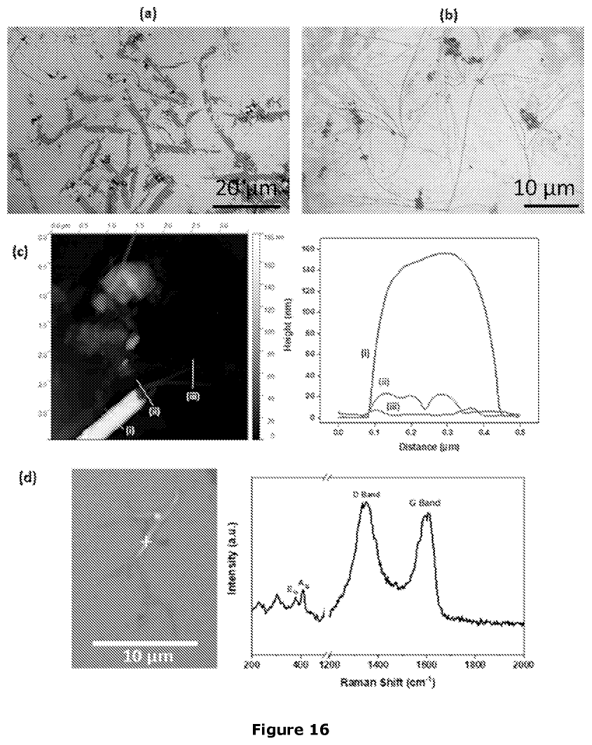

As presented by the SEM images in FIG. 16a, after the mixing process of GO(+) and MoS₂ (−), short nanofibers started to form, with open sheets of 2D materials at the surrounding. Five-minute sonication after the mixing process was conducted to further induce the scrolling of fibers. Long fiber bundles with branches were observed as the majority resulting structures (FIG. 16b). The fibers exist in a wide range of diameter (within 300 nm), with the length up to about 100 μm. Based on the height differences in AFM analysis (FIG. 16c), the fiber appear as the multi-layered scrolled structure, resulted from the scrolling of 2D material sheets over the thin fibers (ii and iii), eventually formed the thick fiber as shown at (i). FIG. 16d shows the Raman characterisation of a branched fiber obtained after the mixing of TETA-GO and MPA-MoS₂. Two dominant GO characteristics peaks, i.e. D band at 1350 cm⁻¹ and G band at 1600 cm⁻¹ are observed. Besides, there are sharp bands located at 378 cm⁻¹ and 410 cm⁻¹. These two bands correspond to the E_{2g} phonon vibration and A_{1g} transition of MoS₂, respectively, indicating the presence of both GO and MoS₂ in the structure.

Herein, a facile aqueous-based self-assembly approach for the synthesis of heterostructure fibers from 2D materials is presented. The long branched fiber bundles can be the attractive materials for various industries such as textile and flexible sensors.

### Experimental Methods

### 2D Material Functionalization

Graphene is first functionalized with 5-azidopentanoic acid (G-COOH). The reaction can be performed in DMSO at about 45° C. under N2 atmosphere for 72 hours. After that, the excess of azido molecules are removed by centrifugation and graphene demonstrate good stability in water. Other non-limiting examples of functionalization are few-layer transition-metal dichalcogenides, such as MoS₂, which can be functionalized with mercaptopropionic acid (MPA) at the sulphur vacancies, also resulting in negatively charged surface.

The graphene sheets conformation is tuned by modifying the properties of the media and the graphene's surface charge is altered by changing the pH.

The system is further functionalized with a polyfunctional molecule namely triethylenetetramine (TETA). For this, the pH of 5 mL of G-COOH 0.04 mg/mL in water is adjusted to 4 and the system is sonicated for 20 min at 10° C. To activate the carboxylic groups, 25 mg of EDC are added and the systems is kept under stirring for 15 min, followed by the addition of 50 mg of NHS. After additional 15 min, 200 μL of TETA (60%) are added and the system is kept under stirring at room temperature for 3 hours. Next, the reaction is transferred to the refrigerator for 72 hours, followed by washing 1× ethanol and 2× in water.

### Synthesis of TETA-GO (GO(+))

GO was functionalised with triethyenetetramine (TETA) using 1-ethyl-3-(3-dimethylaminopropyl)carbodiimide (EDC)/N—Hydroxysuccinimide (NHS) crosslinking method. EDC (100 mg) was added into 0.1 mg/mL GO dispersion, stirred for 15 min at room temperature and sonicated for 5 min at 10° C. Next, 200 mg NHS was added and stirred for 15 min. The reaction mixture was then sonicated for 5 min at 10° C. and 240 μL TETA was added. After stirring for 5 hours at room temperature, the reaction was stopped, and the material was washed with ethanol and deionised water. Right before the synthesis of heterostructure nanofibers, washing step of TETA-GO dispersion was done using diluted hydrochloric acid and water, and the pH was adjusted to around pH 4.5, to allow the protonation of the amino groups and yield positive charges on the GO sheets.

Synthesis of MPA-MoS₂ (MoS₂(−))

MPA-MoS₂ was prepared by adding 50 mg of lithium-intercalated MoS₂ (LixMoS₂) powder into 50 mL of 175 mM 3-mercaptopropionic acid (MPA) aqueous solution. The reaction mixture was sonicated for 30 min at 18° C. and stirred for 2 hours before subjected to another round of sonication for 30 min at 18° C. The functionalised MoS₂ was purified by dialysis process against deionised water for 3 days and freeze-dried. Right before the synthesis of heterostructure nanofibers, the pH of MoS₂ dispersion was adjusted to around pH 8.5, to allow the deprotonation of the carboxylic groups and yield negative charges on the MoS₂ sheets.

### Synthesis of GO(+)/MoS₂(−) Heterostructure Fibers

Firstly, GO(+) and MoS₂(−) were prepared using the methods described above, i.e., GO functionalization using a molecule that allows formation of a positively charged moiety (e.g. TETA) and MoS₂ functionalization using a molecule that allow formation of a negatively charged moiety (e.g. MPA). Secondly, both functionalised 2D materials were sonicated in bath ultrasound for 5 min at 10° C. Using a dual-channel peristaltic pump running at the constant flow of 0.5 rpm, both 2D material dispersions at same concentration (0.05 mg/mL) met at the T-connector to achieve uniform mixing. Then, the dispersion mixture was transported through the tubing connected to T-connector, to allow further mixing along the tube. A vial filled with deionised water was prepared at the end of the tubing for sample collection. Once both dispersions of 2D materials have completed the mixing, the reaction mixture was subjected to another 5 min sonication in bath ultrasound (10° C.).

### Characterization

The substrates (Si, Si/SiO₂ or Si/Au) are washed by immersion in acetone and isopropanol alcohol under sonication (5 min each). The morphology of nanofiber structures is investigated by electron microscopy techniques. For scanning electron microscopy (SEM), samples are drop casted directly onto Si, Au-coated or SiO₂-coated Si substrates and the analyses are carried out in a FEI Verios 460L field-emission scanning electron microscope (FESEM) operating at 2 kV.

Scanning transmission scanning electron microscopy (STEM) and High resolution STEM are performed on Lacey carbon gold TEM grids (TedPella) using FEI Verios 460L FESEM and JEOL JEM-ARM200F atomic resolution analytical microscope, respectively. For the size analysis, the open-source imaging processing ImageJ software is used and approximately 150 structures were manually measured. Optical images are obtained on Si/SiO₂ substrates using an Olympus optical microscope.

For XPS, the dispersions are directly drop casted on Si substrates and dried at room temperature. All spectra are calibrated using the Si peak (99.4 eV) from the silicon substrate.

Shirley type background, peak fitting and quantification are performed by means of CasaXPS software (version 2.1.19). We have performed a deconvolution of the C1s spectrum into an asymmetric peak of graphite (˜284.5 eV) and the other peaks are fitted using Gaussian-Lorentzian GL(30) line shapes. Atomic force microscopy (AFM) images are acquired in a Bruker Dimension Icon Microscope operated in tapping mode and scan lines of 512 and the height profile images are obtained using the open-source AFM image processing tool Gwyddion.

Confocal Raman spectroscopy is carried out in a Witec Alpha 300R, with excitation wavelength of 532 nm and a 100× objective with a numeric aperture of 0.9. For graphene nanofibers, the spectra are normalized with respect to the G band intensity.

### Computational Methods

We performed density functional theory calculations using the SIESTA code to determine the enthalpies of the reactions involved in the crosslinking process. We used the non-local van der Waals density functional. The core electrons are modelled using pseudopotentials of the Troullier-Martins type. The basis sets for the Kohn-Sham states are linear combinations of numerical atomic orbitals (double zeta polarized basis for all species). The charge density is projected on a real-space grid with an equivalent cut-off energy of 250 Ry to calculate the exchange-correlation and Hartree potentials. Structural relaxations are performed using a combination of conjugate gradient optimisation.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of forming a nanofiber, comprising:
a) providing 2D materials with charge bearing moieties on its planar surfaces and at its ends;
b) reacting the charge bearing moieties on the planar surfaces with proton donors, proton acceptors, at least partially hydrophobic counterions or a second 2D materials with oppositely charge bearing moieties on its planar surfaces and at its ends in order to curl the 2D material, and
c) simultaneously reacting the charge bearing moieties at the ends with proton donors, proton acceptors, at least partially hydrophobic counterions or the second 2D materials with oppositely charge bearing moieties on its planar surfaces and at its ends, and crosslinking the neutralised charge bearing moieties at the ends in order for the 2D materials of b) to interact with each other to form the nanofiber.

2. The method according to claim 1, wherein the charge bearing moieties is selected from protonated moieties, deprotonated moieties, cationic moieties or anionic moieties.

3. The method according to claim 1, wherein:
the method is performed in an aqueous medium and the method is performed at about 10° C. to about 50° C.;
at least one of b) and c) is performed at a pH of about 3 to about 6; and
at least b) is performed at about 3° C. to about 10° C. and comprises ultrasonication for at least 10 minutes or stirring.

4. The method according to claim 1, wherein one or more of the following characterizations apply to the method:
the method does not rely on a template in order to form the nanofiber;
when the method is performed at a pH that is maintained, the method is self perpetuating until all 2D materials are reacted; and
when counterions are in excess, the method is self perpetuating until all 2D materials are reacted.

5. The method according to claim 1, wherein the 2D material is selected from the group consisting of graphene, graphene oxide, few-layer transition-metal dichalcogenides, hexagonal boron nitride and combinations thereof, wherein the few-layer transition-metal dichalcogenides is selected from the group consisting of MoS₂, MoSe₂, MoTe₂, WS₂, and WSe₂.

6. The method according to claim 1,
wherein the 2D materials is at least about 50% functionalised with the charge bearing moieties; and
wherein the second 2D materials with oppositely charge bearing moieties is at least about 50% functionalized with the charge bearing moieties.

7. (canceled)

8. The method according to claim 1, wherein the at least partially hydrophobic counterion is selected from the group consisting of imidazolium, pyridinium, piperidinium, ammonium, phosphonium, imide, sulfonate, sulphate, borate, phosphate, carboxylate and their derivatives thereof and wherein the second 2D material with oppositely charge bearing moieties is selected from the group consisting of graphene, graphene oxide few-layer transition-metal dichalcogenides, hexagonal boron nitride and combinations thereof.

9. (canceled)

10. The method according to claim 1, wherein b) further comprises crosslinking the reacted charge bearing moieties on the planar surfaces, wherein the crosslinking is performed in the presence of a crosslinker, wherein the crosslinker comprises at least two cross linking moieties; and wherein a weight ratio of the crosslinker relative to the 2D material is about 50:1 to about 700:1.

11. (canceled)

12. (canceled)

13. The method according to claim 1, wherein the method further comprises functionalising 2D materials with charge bearing moieties in order to form the 2D materials with charge bearing moieties of a), wherein functionalising 2D materials with charge bearing moieties is performed at a pH of about 5 to about 6.9, wherein functionalising 2D materials with charge bearing moieties is performed under ultrasonication, wherein the ultrasonication is for at least 10 min at about 3° C. to about 10° C.;
wherein functionalising 2D materials with charge bearing moieties is performed for at least 2 hours; and
wherein functionalising 2D materials with charge bearing moieties is performed at about 20° C. to about 70° C.

14. (canceled)

15. (canceled)

16. (canceled)

17. (canceled)

18. The method according to claim 1, wherein the method comprises:
a) providing 2D materials with protonated or deprotonated moieties on its planar surfaces and at its ends;
b) reacting the protonated or deprotonated moieties on the planar surfaces with proton donors or proton acceptors in order to curl the 2D material, and
c) simultaneously reacting the protonated or deprotonated moieties at the ends with proton donors or proton acceptors and covalently crosslinking the reacted moieties at the ends in order for the 2D materials of b) to interact with each other to form the nanofiber;
wherein the protonated or deprotonated moieties are carboxylate moieties, and wherein each of the carboxylate moieties is a carboxyl compound independently selected from the group consisting of 5-azidopentanoic acid, 6-azido-hexanoic acid, azido-dPEG4-acid, azido palmitic acid, azidoacetic acid, mercaptopropionic acid, mercaptoacetic acid, 5-mercaptopentanoic acid, and combinations thereof.

19. (canceled)

20. (canceled)

21. The method according to claim 18, wherein b) further comprises covalently crosslinking the reacted protonated or deprotonated moieties on the planar surfaces.

22. The method according to claim 18, wherein the protonated or deprotonated moieties are covalently crosslinked with amino compounds, wherein amino compounds comprise at least two amino moieties; and wherein the amino compounds are selected from the group consisting of triethylenetetramine, triethylenediamine, ethylenedimine, p-phenvlenediamine, and combinations thereof.

23. (canceled)

24. (canceled)

25. The method according to claim 1, wherein the method comprises:
a) providing 2D materials with cationic or anionic moieties on its planar surfaces and at its ends;
b) reacting the cationic or anionic moieties on the planar surfaces with at least partially hydrophobic counterions in order to curl the 2D material, and
c) simultaneously reacting the cationic or anionic moieties at the ends with at least partially hydrophobic counterions and ionically crosslinking the reacted charge bearing moieties at the ends in order for the 2D materials of b) to interact with each other to form the nanofiber;
wherein the cationic or anionic moieties are electrostatically bonded to the 2D materials;
wherein a ratio of 2D materials to the cationic or anionic moieties is about 1:30 to about 1:80; and
wherein the cationic or anionic moieties are organic cationic or anionic moieties.

26. (canceled)

27. (canceled)

28. (canceled)

29. (canceled)

30. The method according to claim 25, wherein the charge bearing moieties are reacted by counterions having an opposite charge relative to the cationic or anionic moieties on the 2D material,
wherein the counterions are organic counterions selected from imidazolium, pyridinium, piperidinium, ammonium, phosphonium, imide, sulfonate, sulphate, borate, phosphate, carboxylate or their derivative thereof; and
wherein a ratio of 2D materials with cationic or anionic moieties to the counterions is about 1:30 to about 1:80.

31. (canceled)

32. (canceled)

33. (canceled)

34. The method according to claim 25, wherein b) further comprises ionically crosslinking the reacted cationic or anionic moieties on the planar surfaces.

35. (canceled)

36. The method according to claim 25, wherein the method further comprises functionalising 2D materials with cationic or anionic moieties in order to form the 2D materials with cationic or anionic moieties of a), wherein the functionalising 2D materials with cationic or anionic moieties is performed under ultrasonication in the presence of cationic or anionic moieties, and wherein the ultrasonication is performed for at least 10 min at about 3° C. to about 10° C.

37. (canceled)

38. The method according to claim 1, wherein the method comprises:
a) providing 2D materials with cationic or anionic moieties on its planar surfaces and at its ends;
b) reacting the cationic or anionic moieties on the planar surfaces with another 2D materials with oppositely charge bearing moieties on its planar surfaces and at its ends in order to curl the 2D material, and
c) simultaneously reacting the cationic or anionic moieties at the ends with the another 2D materials with oppositely charge bearing moieties on its planar surfaces and at its ends and ionically crosslinking the reacted charge bearing moieties at the ends in order for the 2D materials of b) to interact with each other to form the nanofiber;
wherein a weight ratio of the 2D materials relative to the another 2D materials is about 1:1.

39. (canceled)

40. (canceled)

41. A nanofiber,
wherein the nanofiber is characterised by a solid or semi-hollow cross sectional profile;
wherein the nanofiber is characterised by a layered cross sectional profile of 2D materials curled up and bonded to each other at their planar surfaces and ends; and
wherein the 2D materials are selected from graphene, graphene oxide, few-layer transition-metal dichalcogenides, hexagonal boron nitride or a combination thereof.

42. The nanofiber according to claim 41, wherein the nanofiber is characterised by at least one of the following:
a diameter of about 5 nm to about 400 nm;
a length of about 1 μm to about 100 μm;
a diameter of the nanofiber is inhomogeneous:
an aspect ratio of the nanofiber is about 100 to about 3000; and
the nanofiber is semicrystalline.

43. (canceled)

44. (canceled)

45. (canceled)

46. The nanofiber according to claim 41, wherein the nanofiber is a graphene nanofiber, and the nanofiber is characterised by at least one of the following:
an interlayer spacing of about 0.40 nm to 0.5 nm;
amide bonds and an X-ray photoelectron spectroscopy peak at about 288 eV to about 290 eV; and
amide bonds and FTIR peaks at about 1653 cm⁻¹ and about 1572 cm-1.

47. (canceled)
